(19) United States
(12) Patent Application Publication
(10) Pub. No.: US 2026/0241870 A1
(43) Pub. Date: Aug. 20, 2026

(54) LOAD CARRIER

(71) Applicant: Kuat Innovations LLC, Springfield, MO (US)

(72) Inventors: Jonathan Graif, Springfield, MO (US); Aaron Houston, Springfield, MO (US); Luke Kuschmeader, Springfield, MO (US); Austin Beymer, Springfield, MO (US); Clayton Villars, Springfield, MO (US)

(21) Appl. No.: 19/529,437

(22) Filed: Feb. 4, 2026

Related U.S. Application Data
(60) Provisional application No. 63/755,664, filed on Feb. 7, 2025.

(51) Int. Cl. B60R 9/10; B60R 9/06

(52) U.S. Cl. CPC B60R 9/10; B60R 9/06

(57) ABSTRACT

A load carrier for a vehicle comprises a vehicle attachment portion, a pivot mechanism connected to the vehicle attachment portion, a support beam connected to the pivot mechanism, and a safety mechanism configured to prevent disengagement of the pivot mechanism, wherein the pivot mechanism engages to hold the support beam in a stowed position and a deployed position with respect to the support beam. The safety mechanism may comprise a safety release actuator and a safety latch mounted on the pivot mechanism, wherein the safety release actuator is configured to disengage the safety latch from the pivot mechanism. The safety mechanism may further comprise a safety indicator component with a visual warning indicator.

### CROSS-REFERENCE TO RELATED APPLICATIONS

This application claims the benefit of the priority of U.S. Provisional Patent Application No. 63/755,664 filed on Feb. 7, 2025.

### BACKGROUND OF THE INVENTION

The load carrier is in the field of cargo carriers for use with automobiles or other motor vehicles. More specifically the load carrier is in the field of carriers for recreational equipment, such as bicycles among others, for use with automobiles or other motor vehicles.

### SUMMARY OF THE INVENTION

In some embodiments, the inventive load carrier comprises a safety mechanism for preventing rotation of a pivot hub actuator. In some embodiments the safety mechanism provides a visual indicator of its configuration.

In some embodiments, the inventive load carrier comprises lower tire chock that slides on the tire platform. In some embodiments the sliding lower tire chock includes a tire strap disposed through a passage in the tire chock. In some embodiments the tire chock is held at a desired position on the tire platform by the tire.

In some embodiments, the inventive load carrier comprises an adjustable tire chock. In some embodiments, the adjustable tire chock slides in channels provided in the tire securement arm. In some embodiments, the adjustable tire chock is held in a desired position by locking pins that extend only partially through the side members of the tire securement arm.

In some embodiments, the inventive load carrier comprises a tire securement arm with internal structural blocks. In some embodiments the internal structural blocks are provided at the distal and proximal ends of the tire securement arm.

In some embodiments, the inventive load carrier comprises a support arm mechanism disposed in cavities or channels provided in the base of the load carrier. In some embodiments, the support arm mechanism includes a linear ratchet disposed in a channel in the base. In some embodiments, the support arm mechanism includes a latch assembly slidably disposed in two channels in the base.

In some embodiments, the inventive load carrier comprises a front tire chock disposed on the base of the load carrier. In some embodiments the front tire chock has a retaining face for holding a bicycle tire in position.

### BRIEF DESCRIPTION OF DRAWINGS

FIG. 1A is a perspective view of an embodiment of the inventive load carrier in a closed configuration.

FIG. 1B is a perspective view of an embodiment of the inventive load carrier with two tire securement arms in an open configuration.

FIG. 1C is an end view of an embodiment of the inventive load carrier in an open configuration.

FIG. 2A is a detail, perspective view of a lower end portion with a safety mechanism in an embodiment of the inventive load carrier.

FIG. 2B is a perspective view of a lower end portion with a safety mechanism in an embodiment of the inventive load carrier.

FIG. 2C is a detailed perspective view of an actuator for a pivot hub of a lower end portion of an embodiment of the inventive load carrier with a safety mechanism in an engaged configuration.

FIG. 2D is a detailed perspective view of an actuator for a pivot hub of a lower end portion of an embodiment of the inventive load carrier with a safety mechanism in a disengaged configuration.

FIG. 2E is a front view of an actuator for a pivot hub of an embodiment of the inventive load carrier with a safety mechanism in an engaged configuration.

FIG. 2F is a front view of an actuator for a pivot hub of an embodiment of the inventive load carrier with a safety mechanism in a disengaged configuration.

FIG. 2G is a right-side view of an actuator for a pivot hub of an embodiment of the inventive load carrier.

FIG. 2H is a left-side view of an actuator for a pivot hub of an embodiment of the inventive load carrier.

FIG. 2I is a cross-sectional view of the actuator for a pivot hub of an embodiment of the inventive carrier on the plane shown as a dotted line in FIG. 2G with the safety mechanism in an engaged configuration.

FIG. 2J is a cross-sectional view of the actuator for a pivot hub of an embodiment of the inventive carrier on the plane shown as a dotted line in FIG. 2G with the safety mechanism in a disengaged configuration.

FIG. 2K is an exploded view of the safety mechanism for an embodiment of the inventive load carrier.

FIG. 2L is a cross-sectional view of the handle of the safety mechanism for an embodiment of the inventive load carrier.

FIG. 3A is a perspective view of a tire chock mechanism of an embodiment of the inventive load carrier.

FIG. 3B is a cross-sectional view of a tire chock mechanism of an embodiment of the inventive load carrier.

FIG. 3C is a side view of components of a tire chock mechanism for an embodiment of the inventive load carrier.

FIG. 3D is a bottom view of components of a tire chock mechanism for an embodiment of the inventive load carrier.

FIG. 3E is a front view of components of a tire chock mechanism for an embodiment of the inventive load carrier.

FIG. 3F is a back view of components of a tire chock mechanism for an embodiment of the inventive load carrier.

FIG. 3G is an exploded, upper perspective view of components of a tire chock mechanism for an embodiment of the inventive load carrier.

FIG. 3H is an exploded, lower perspective view of components of a tire chock mechanism for an embodiment of the inventive load carrier.

FIG. 4A is a detail perspective view of an adjustable tire chock mechanism on a tire securement arm for an embodiment of the inventive load carrier.

FIG. 4B is a front plan view of an adjustable tire chock mechanism on a tire securement arm for an embodiment of the inventive load carrier.

FIG. 4C is a cross-sectional view of an adjustable tire chock mechanism on a tire securement arm for an embodiment of the inventive load carrier on the plane shown as a dotted line in FIG. 4B.

FIG. 4D is a perspective view of the adjustable tire chock mechanism of an embodiment of the inventive load carrier.

FIG. 4E is an exploded view of the adjustable tire chock mechanism of an embodiment of the inventive load carrier.

FIG. 5A is a detail perspective view of a tire securement arm assembly of an embodiment of the inventive load carrier.

FIG. 5B is an exploded view of a tire securement arm assembly of an embodiment of the inventive load carrier.

FIG. 5C is a cross-sectional view of a tire securement arm assembly of an embodiment of the inventive load carrier on a plane parallel to the longitudinal axis of the tire securement arm assembly.

FIG. 6A is a detail perspective view of a connection of a tire securement arm assembly to the base member of the bicycle support assembly of an embodiment of the inventive load carrier.

FIG. 6B is an exploded view of a connection of a tire securement arm assembly to the base member of the bicycle support assembly of an embodiment of the inventive load carrier.

FIG. 6C is an exploded view of a connection of a tire securement arm assembly to the base member of the bicycle support assembly of an embodiment of the inventive load carrier.

FIG. 6D is a cross-sectional view of the connection of a tire securement arm assembly to the base member of the bicycle support assembly of an embodiment of the inventive load carrier on a plane through the pivot bolt 602k on the plane parallel to the end face of end cap 602h.

FIG. 6E is a perspective view of a structural end cap for a base member of an embodiment of the inventive load carrier.

FIG. 7A is a perspective view of an adjustable support arm assembly or mechanism of an embodiment of the inventive load carrier.

FIG. 7B is a cross-sectional view of the adjustable support arm assembly of an embodiment of the inventive load carrier on the plane shown by the dotted line labelled 7B in FIG. 7C.

FIG. 7C is a top plan view of a portion of an embodiment of the inventive load carrier.

FIG. 7D is a cross-sectional view of the adjustable support arm assembly of an embodiment of the inventive load carrier on the plane shown by the dotted line labelled 7D in FIG. 7B with a latch assembly in an engaged configuration.

FIG. 7E is a cross-sectional view of the adjustable support arm assembly of an embodiment of the inventive load carrier on the plane shown by the dotted line labelled 7D in FIG. 7B with a latch assembly in a disengaged configuration.

FIG. 7F is an exploded view of components of a support arm assembly of an embodiment of the inventive load carrier.

FIG. 7G is an exploded view of components of a support arm assembly of an embodiment of the inventive load carrier.

FIG. 8A is a perspective view of a portion of an embodiment of the inventive load carrier with a lower front tire chock.

FIG. 8B is a side plan view of components of a lower front tire chock of an embodiment of the inventive load carrier.

FIG. 8C is an end plan view of components of a lower front tire chock of an embodiment of the inventive load carrier.

FIG. 8D is a top plan view of components of a lower front tire chock of an embodiment of the inventive load carrier.

FIG. 8E is a cross-sectional view of components of a lower front tire chock of an embodiment of the inventive load carrier in the plane shown as a dotted line in FIG. 8C.

FIG. 8F is a cross-sectional view of a lower front tire chock on a bicycle support tray of an embodiment of the inventive load carrier in the plan shown as a dotted line in FIG. 8D.

FIG. 8G is an exploded view of components of a lower front tire chock of an embodiment of the inventive load carrier.

FIG. 8H is an exploded view of components of a lower front tire chock of an embodiment of the inventive load carrier.

### DETAILED DESCRIPTION

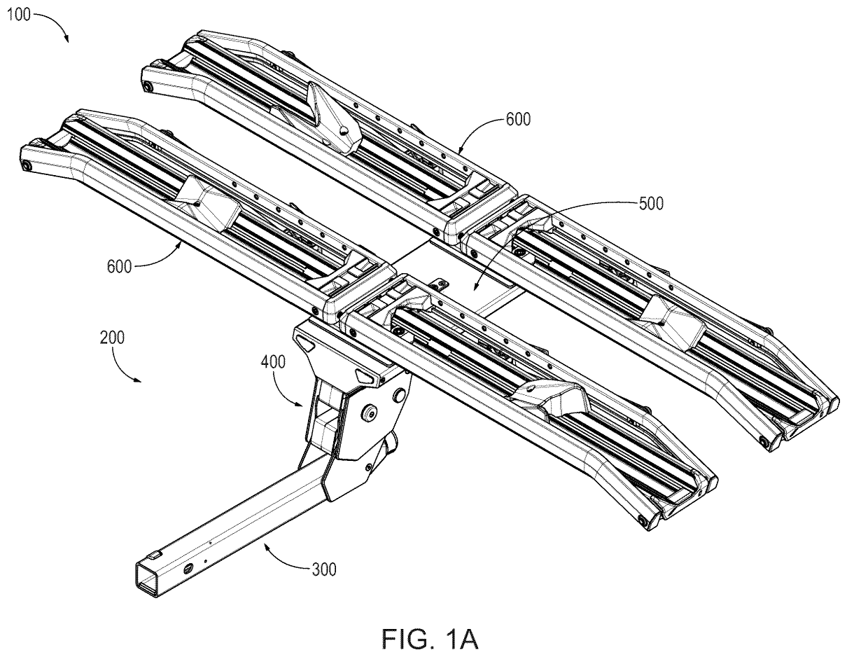

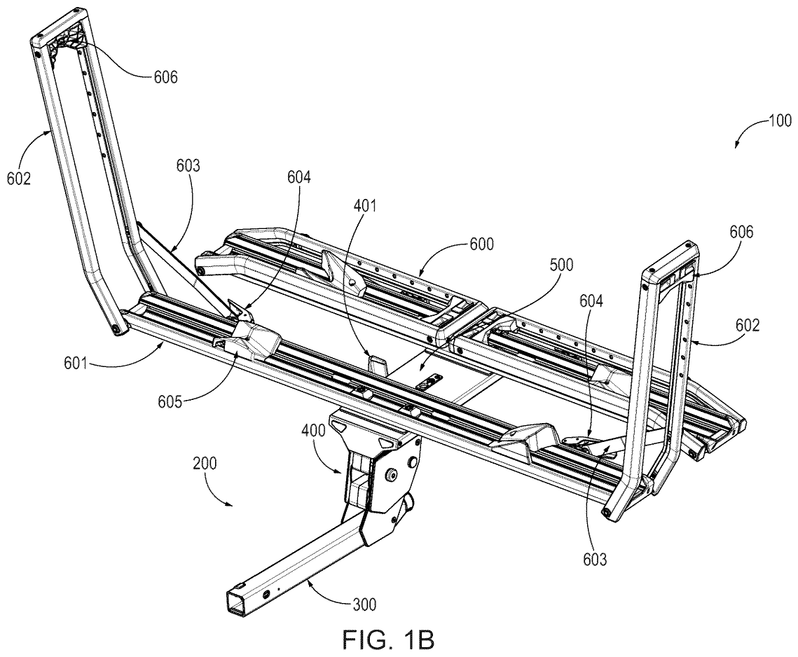

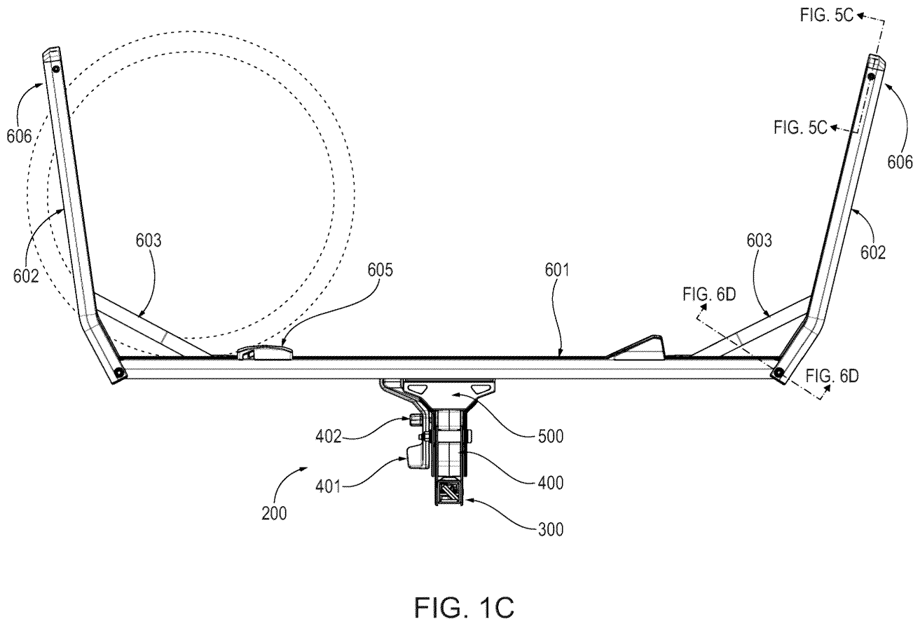

Referring now to FIGS. 1A, 1B, and 1C, an embodiment of the inventive load carrier 100 is depicted. The load carrier 100 in varying embodiments may include only some of the inventive components and mechanisms described herein. The inventive components and mechanisms may be independent of one another in varying embodiments. For example, some of the inventive concepts and mechanisms in the bicycle support assembly 600 may be included in embodiments of the load carrier that do not include any of the components of the lower end 200. And similarly, some load carriers that incorporate inventions in the lower end 200 may not include a bicycle support assembly 600 at all. The scope of the invention shall be determined by the scope of the claims, and not by the features of any one embodiment.

The depicted embodiment of the load carrier 100 includes a lower end 200 that is comprised of a vehicle attachment assembly, component, portion or member 300, a pivot mechanism 400, and a support beam 500. The vehicle attachment assembly or member 300 comprises a mechanism for attaching the load carrier to a vehicle. In some embodiments, such as the depicted embodiment, the vehicle attachment member 300 may comprise a drawbar for a receiver hitch. In some of these embodiments the drawbar may be provided with an internal clamp mechanism such as that described in U.S. Pat. No. 11,427,045, or other similar mechanisms. In other embodiments the vehicle attachment portion 300 may comprise a tow ball clamp mechanism for clamping onto a tow ball. In other embodiments, the vehicle attachment portion 300 may be configured to support the load carrier on the trunk lid of an automobile. In yet other embodiments relating to bicycle support assembly 600, there may be no lower end 200 at all, and the bicycle support assembly may be mounted to the motor vehicle by some other attachment method such as clamping to a cargo rack or roof-mounted crossbars. Conversely, the inventive aspects of the lower end 200 may be used in cargo carriers that do not include bicycle support assembly 600, that carry bicycles in a manner different from that described herein, or that do not carry bicycles at all but instead carry other types of cargo.

In the depicted embodiment, the lower end includes an optional pivot hub 400 that allows the support beam 500 to be pivoted with respect to the vehicle attachment portion 300. This allows the support beam and attached components in some embodiments to be reconfigured from a deployed configuration shown in FIGS. 1A-1C to one or more other configurations. Such other configurations may include those disclosed in U.S. Pat. No. 11,643,021 for stowing vertically or declining to provide access to the rear of the motor vehicle.

In varying embodiments, the load carrier 100 is provided with a carrier assembly for receiving and holding cargo or equipment to be transported on the load carrier 100. The embodiment of the load carrier 100 depicted in the figures is provided with one or more bicycle support assemblies 600 to serve as the carrier assembly. The depicted bicycle support assembly 600 secures a bicycle on the base member or tray 601 by means of two tire securement arms 602. The tire arms 602 may contact the bicycle tires in the manner shown in FIG. 1C which depicts a bicycle tire in dotted lines. In the depicted embodiment there are two such arms 602 on each tray 601. In other embodiments of the load carrier, other types of bicycle support assembly 600 may be used, for example load carriers 100 with the inventive mechanisms of the lower end portion 200 may utilize other types of bicycle carriers or even non-bicycle cargo carriers on the support member 500.

### Safety Mechanism Embodiments

Some embodiments of the inventive load carrier comprise a safety mechanism that provides a visual indication of whether the pivot hub actuator is engaged or disengaged. Some of these embodiments also provide a physical obstruction to accidental disengagement of the pivot hub actuator.

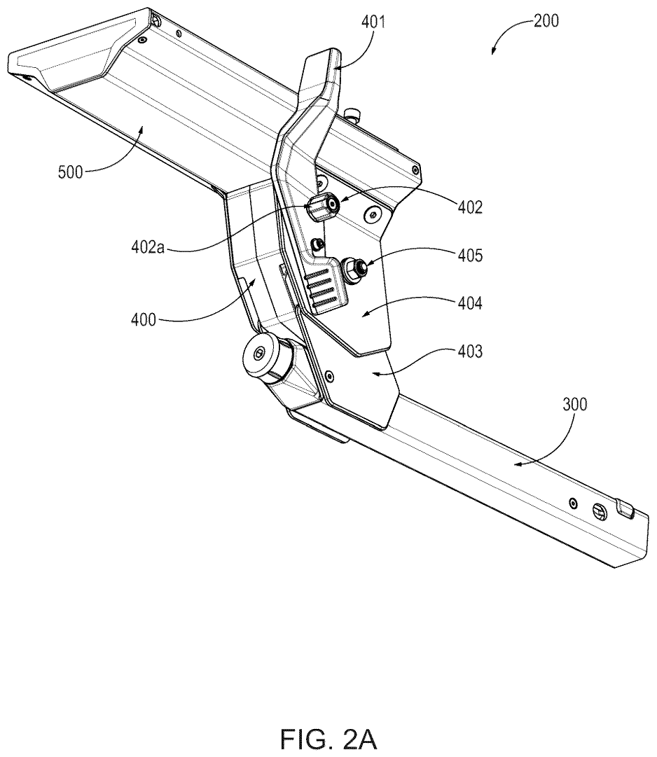

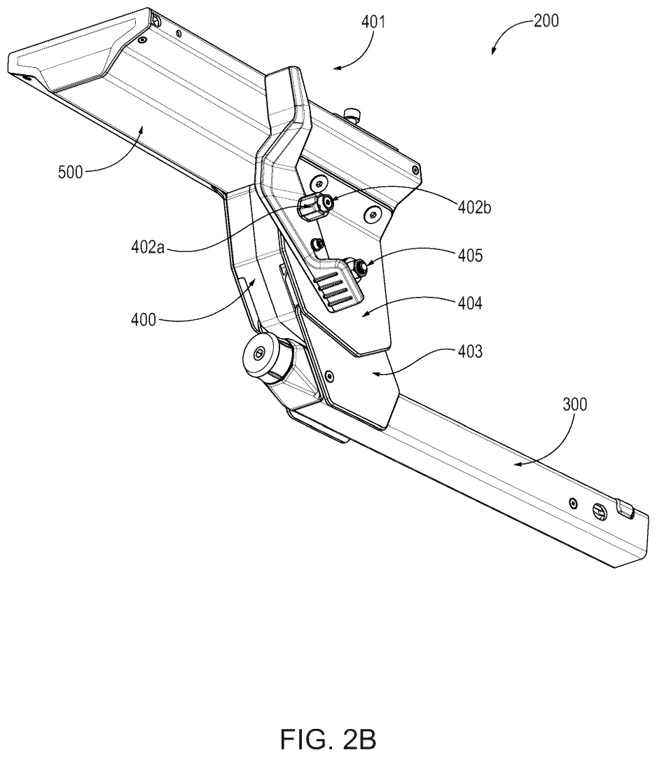

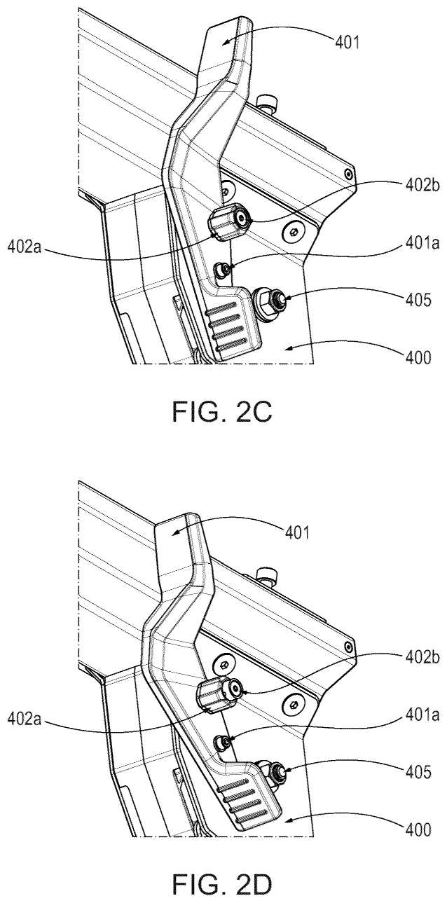

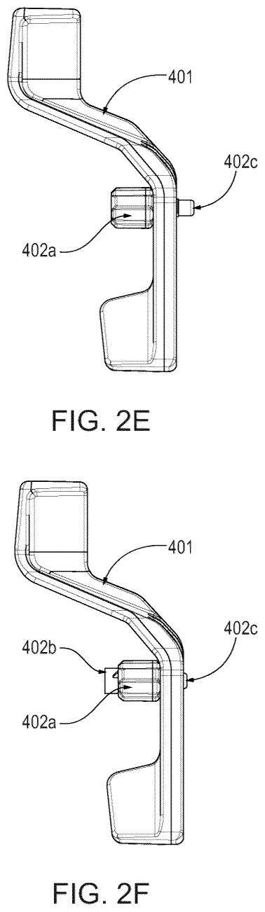

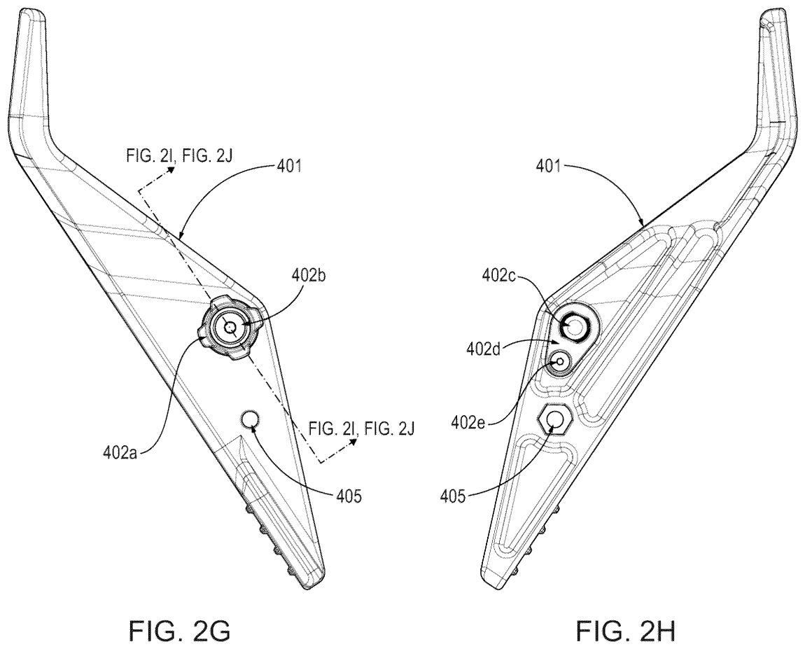

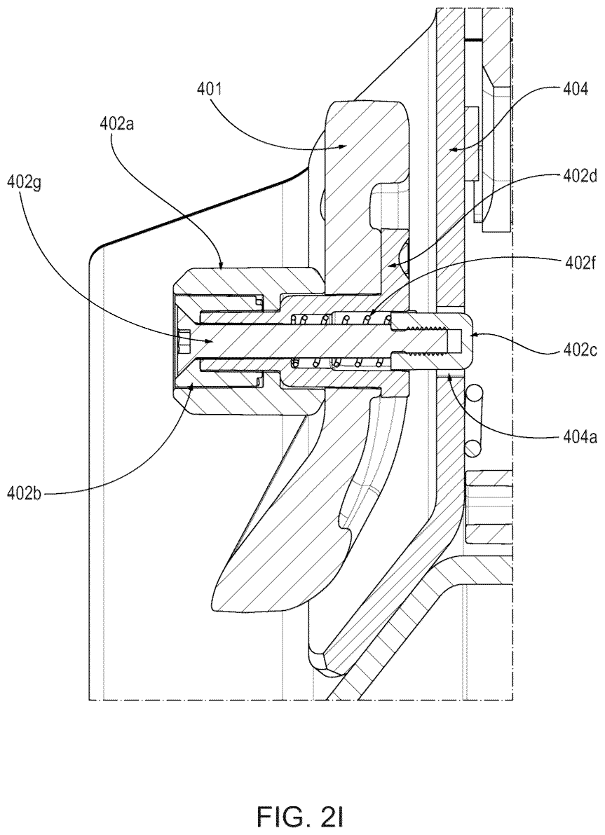

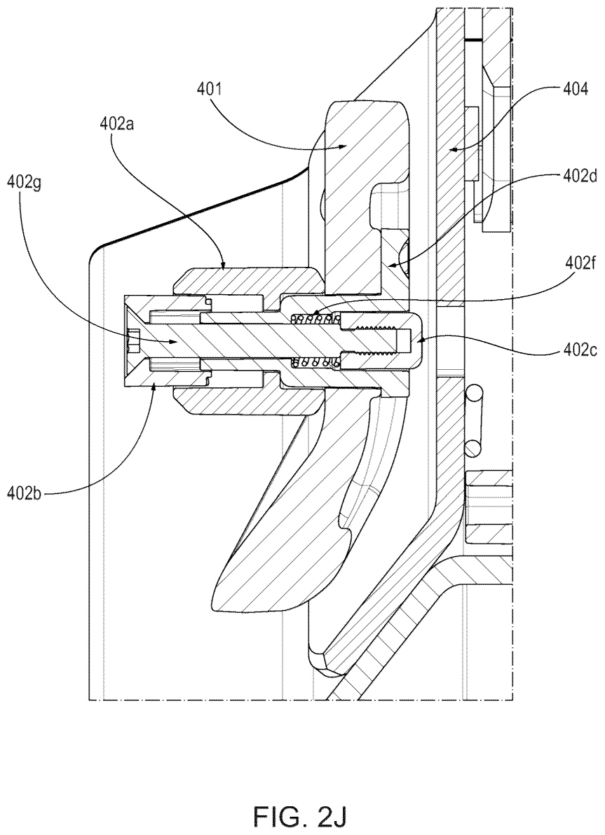

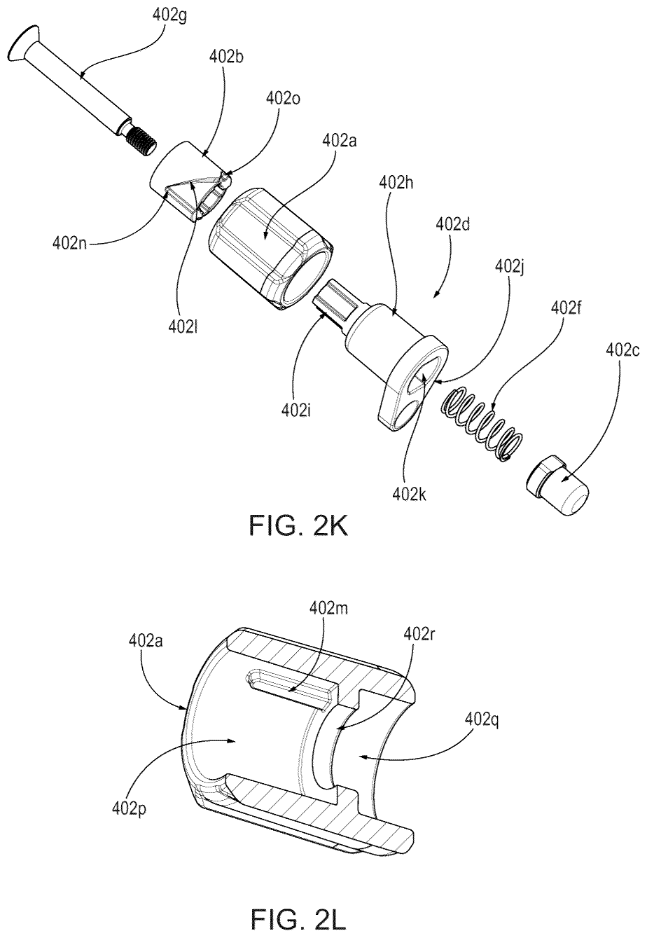

Referring to FIGS. 2A-2L, a depiction of an embodiment of a pivoting hub 400 with an inventive safety mechanism 402 incorporated in the pivot mechanism is shown. Pivoting hub 400 is provided with an actuator or release handle 401 configured to disengage the pivot mechanism in the hub 400, such as the mechanism described in U.S. Pat. No. 11,643,021. Rotating the actuator 401 around bolt 401a may allow plates 404 to pivot with respect to fixed plates 403 around pivot bolt 405. This rotation of the plates 404 also rotates the support member 500 and anything attached to it, allowing reconfiguration from stowed to deployed to declined configurations as disclosed in the above referenced patent.

The safety mechanism 402 may be provided to provide a visible indication that the actuator 401 is in the engaged or disengaged position to prevent the pivot hub from pivoting at an undesirable time. The safety mechanism 402 may also provide a physical obstruction to the movement of the actuator 401 to prevent it from disengaging when not desired. The safety mechanism 402 is shown in the depicted embodiment installed on the actuator 401 and engaging the rotating plate 404 but in other embodiments it could be installed on the rotating plate 404 and engage the fixed plate 403.

The depicted embodiment of the safety mechanism 402 comprises a handle, knob, or other actuator 402a that a user can manipulate to disengage the safety mechanism 402. The safety mechanism 402 must be disengaged to allow the pivot hub 400 to pivot from one configuration to another, in this embodiment by preventing movement of the actuator 401 that disengages the hub mechanism. In the depicted embodiment a user turns the knob 402a either a half or quarter turn to retract the safety latch from its latched position, which in this embodiment is locking pin 402c out of a hole—blind or otherwise, cavity, aperture, detent, or other indentation in the rotating plate 404 that aligns with the locking pin 402c only when the actuator 401 is in the engaged position with respect to the pivot hub 400.

FIGS. 2C, 2E, and 2I show an embodiment of the engaged safety mechanism 402. In the engaged or extended position, the locking pin 402c extends out from the surface of the actuator 401 to enter into aperture 404a in the fixed plate 404, and the engagement indicator/safety indicator 402b is retracted into a cavity in handle 402a. A biasing mechanism 402f is provided to urge the locking pin 402c into the aperture in the plate 404 whenever they are aligned. In the depicted embodiment the locking pin 402c is attached to a first end of a retention member or machine screw 402g, and the engagement indicator component 402b is attached or disposed at a second end of the retention member 402g. In this embodiment the combination of 402c, 402g, and 402 b is able to slide in an aperture 402k in retaining member 402d. The retaining member 402d is configured to attach to the actuator 401 in this embodiment by a fastener attached through a hole in flange 402j, or to other plates such as 404 in other embodiments. The retaining member 402d provides support to the other components of the safety mechanism 402 and holds them in place with respect to each other and the actuator 401.

FIGS. 2D, 2F, and 2J show an embodiment of the disengaged safety mechanism 402. In the disengaged position, the locking pin 402c has been retracted into the retaining member 402d (allowing the actuator 401 to move with respect to plate 404) and the engagement indicator/safety indicator 402b extends out of the handle 402a to display a warning color or other visual warning indicator/area to a user.

The handle 402a may receive a portion of bushing 402h in the aperture in the second end 402q of the handle 402a, defined by the flange 402r on the inner surface of the handle 402a, and may rotate or pivot thereon. In the depicted embodiment the handle 402a is retained on the retaining member because it is disposed between the retaining member 402d and the engagement indicator 402b. The engagement indicator 402b may be constrained to slide up and down without rotating with respect to the retaining member 402d by guide members 402i (on retaining member 402d) that are received by slots on the inner surface of the aperture in the engagement indicator 402b.

In varying embodiments, the engagement indicator will by color or shape be visually perceptible to a user when the locking pin is retracted from the aperture in the plate 404. In the depicted embodiment the cavity 402p in the first end of handle 402a receives the engagement indicator 402b, so that when the pin 402c is retracted into the retaining member 402d the engagement indicator will be extended out from the cavity 402p in the handle 402a. In some embodiments the cylindrical sides of engagement indicator 402b may be colored red or some other color or pattern that will draw the attention of the user so that they easily determine that the locking pin 402c is not engaged with plate 404.

If the locking pin 402c is extended and engaged in the aperture in plate 404, a user must retract it before using actuator 401 to disengage the mechanism in pivot hub 400. In the depicted embodiment a user rotates handle 402a through a partial turn to retract locking pin 402c. The rotation of handle 402a in the depicted embodiment causes rib 402m on the interior of cavity 402p of handle 402a to engage the angled lip 402l provided on engagement indicator 402b. When the rib 402m is positioned at the first end 402n of the lip 402l the engagement indicator is able to retract into the handle 402a and the locking pin can extend into the aperture in plate 404. As the user turns handle 402a the end of rib 402m pushes on the angled lip 402l to push the engagement indicator 402b out of the cavity 402p, which pulls fastener 402g and locking 402c outward from the aperture in plate 404. In some embodiments a depression or indentation is provided at a second end 402o of the angled lip 402l to receive the end of rib 402m and hold the engagement indicator in the outward position shown in FIG. 2J until a user turns the handle in the other direction to remove the end of the rib 402m from the depression.

### Lower Rear Tire Chock Embodiments

In some embodiments of the inventive load carrier, a lower tire chock is provided that can slide along all or a part of the length of the tray in the bicycle support assembly. The inventive tire chock has a passage to allow a tire strap to pass between the chock and the tray so that the chock can slide along the tray with the strap in place. In some embodiments the tire chock is held in a desired position by the bicycle tire. In other words it is not necessary to tighten the chock down to the tray when using it to secure a bicycle on the load carrier. Strapping it to the bicycle tire will sufficiently secure it in place to serve its purpose as a tire chock.

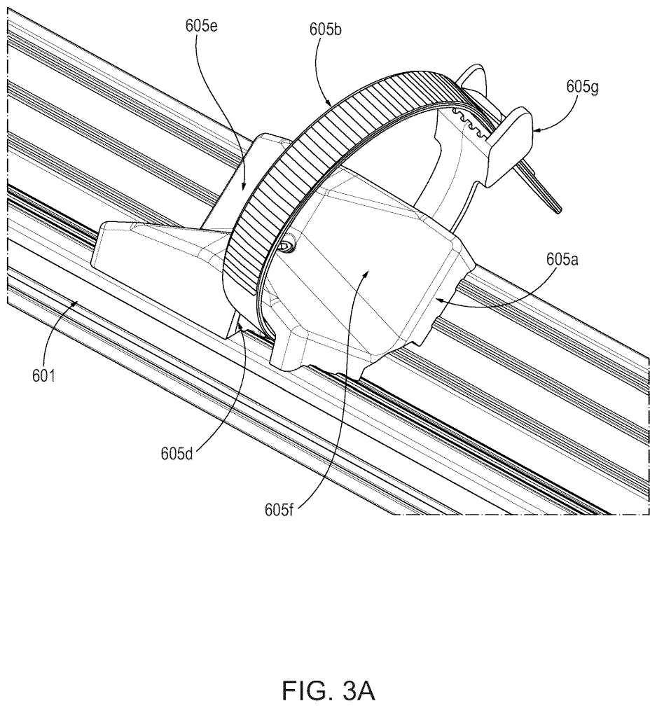

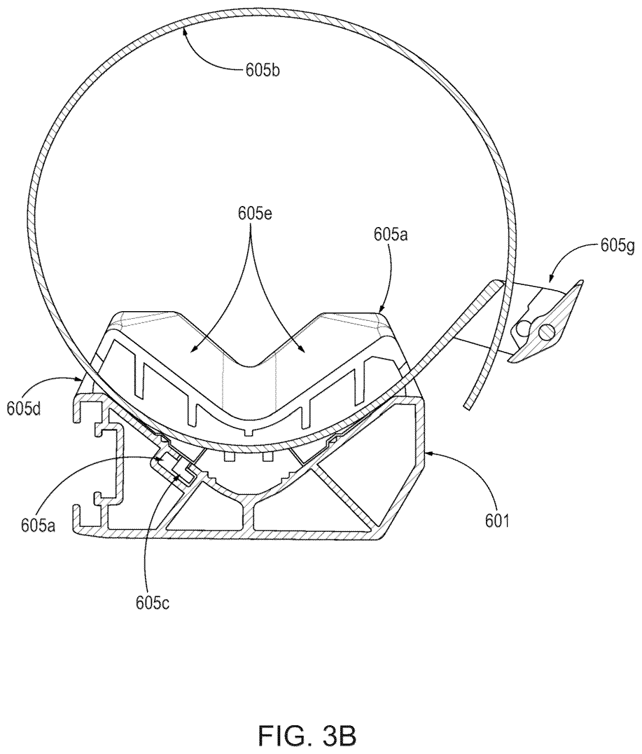

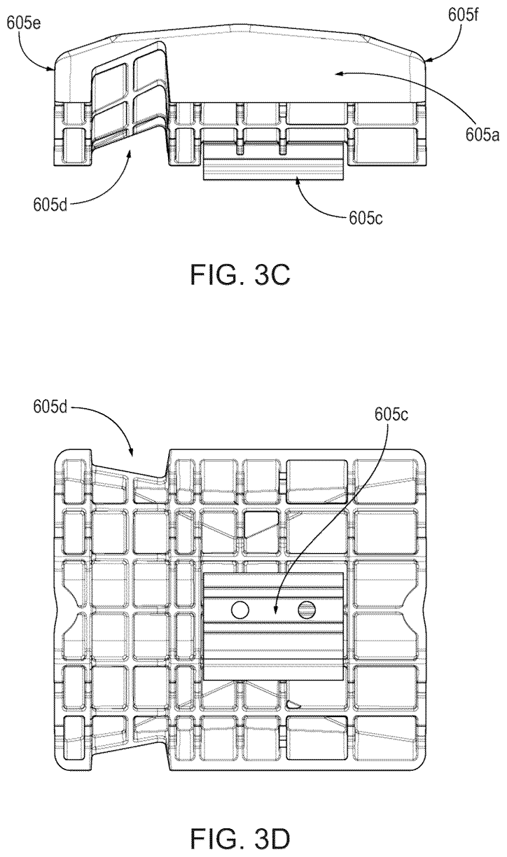

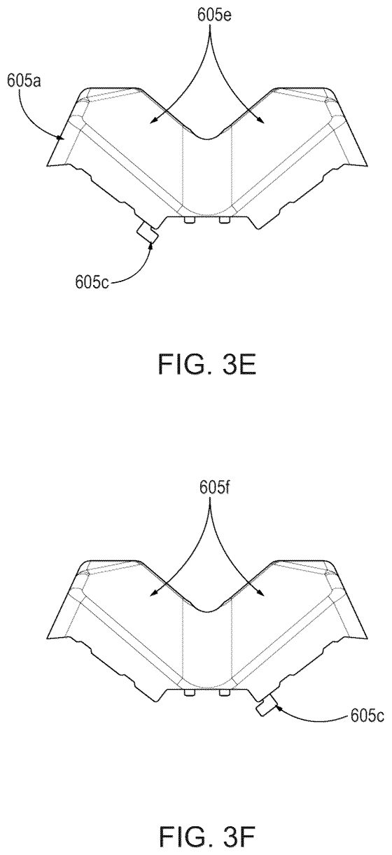

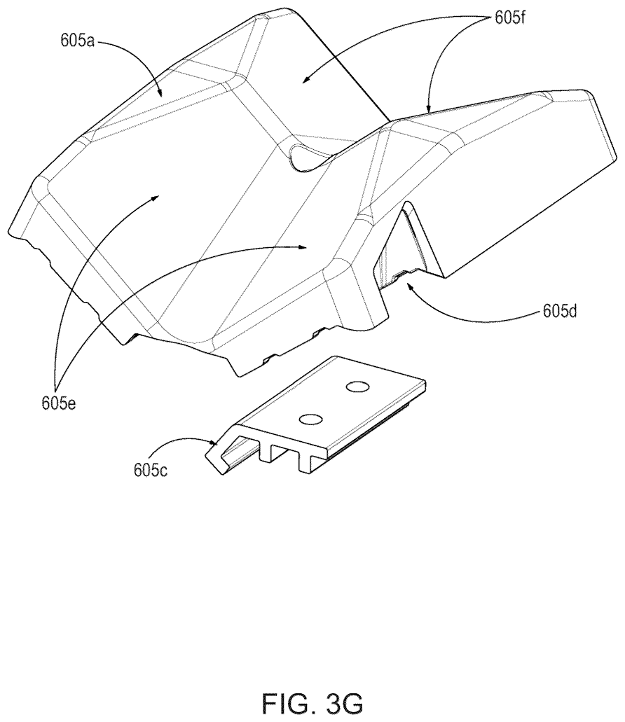

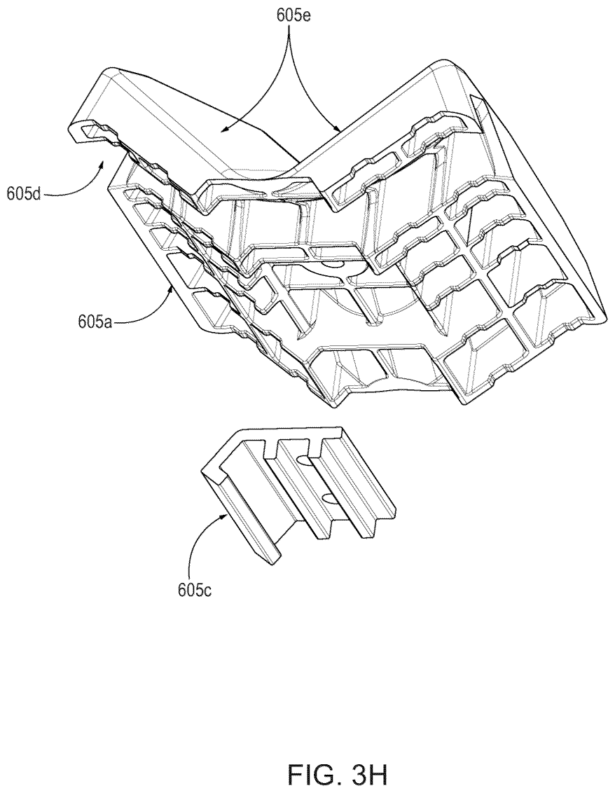

Referring now to FIGS. 3A-3H, an inventive rear tire chock 605 is depicted for use with base member or tray 601. In some embodiments it may be useful to have a chock on the base member 601 for added support for larger or heavier bicycles. In some embodiments the chock 605 is slidably adjustable along the length of the base member 601 or a portion thereof, to allow a user to adjust its position for different sizes of bicycles and tires. In the depicted embodiment the chock 605 comprises a chock body 605a, a tire strap 405b, and a retaining component 605c. The chock body 605a may be injection-molded plastic, cast or machined metal, or other materials with similar properties and durability. The lower surface of the chock body 605a may be designed to slidingly rest on the surface of the base member 601. It may directly rest thereon or there may be intermediate components between them. In the depicted embodiment a retaining component 605c is provided to prevent the chock body 605a from disconnecting from the base member 601 while allowing the chock body 605a to slide along it without the use of tools. In the depicted embodiment the retaining component 605c comprises a flange with a connecting plate. The connecting plate is provided with an aperture for a fastener or other means for attaching the component 605c to the chock body 605a.

The flange of the depicted embodiment of retaining member 605c is configured to be slidably retained in a channel 601a in the base member 601. The channel 601a may run the length or only a portion of the length of the base member 601. The flange of retaining member 605c may be t-shaped or L-shaped (as depicted) to engage one or more rims of the channel 601c.

The retaining strap 605b may be a ratchet strap (as depicted) or another commonly used strap such as a hook and look fastener strap, an elastic strap, or others. The chock body 605a is provided with a passage 605d to allow the strap 605b to pass between and be retained by the chock body 605a and the base member 601. The passage may be formed from a series of notches in ribs comprising the internal structure of the chock body 605a, or otherwise as required based on the structure of the chock body 605a. In use the strap will be fed through the passage and around the wheel of a bicycle to securely fasten it to the chock.

The upper surface of the chock body 605a may be shaped to ease rolling a bicycle tire 900 over the chock body 605a while loading a bicycle onto the load carrier. In the depicted embodiment, each side 605e and 605f of the upper surface of the chock body 605a has a V-shaped or U-shaped contour that also ramps upwardly toward the middle of the chock body 605a. The angles of the two sides 605e and 605f may be the same, as depicted, or at different angles. In some embodiments face 605e may be steeper with respect to the base member 601 to provide more holding force to resist a tire 900 rolling over it while clamped in place.

### Adjustable Upper Tire Chock Embodiments

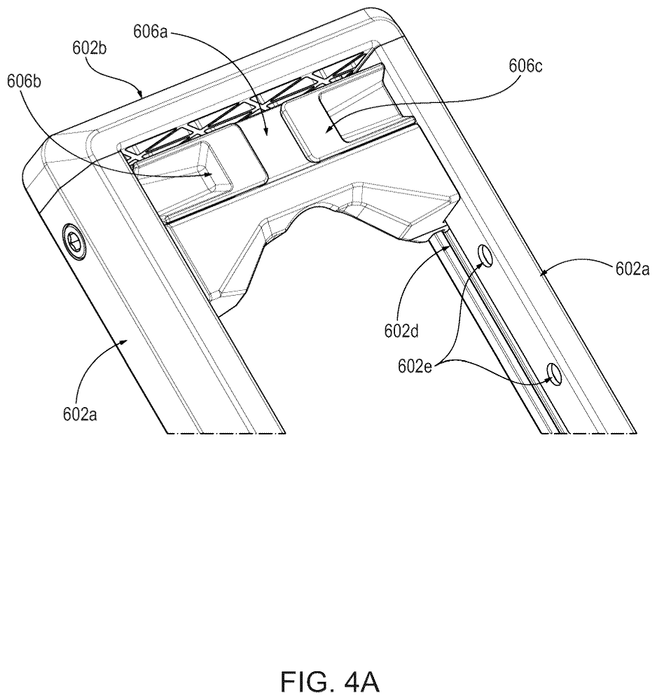

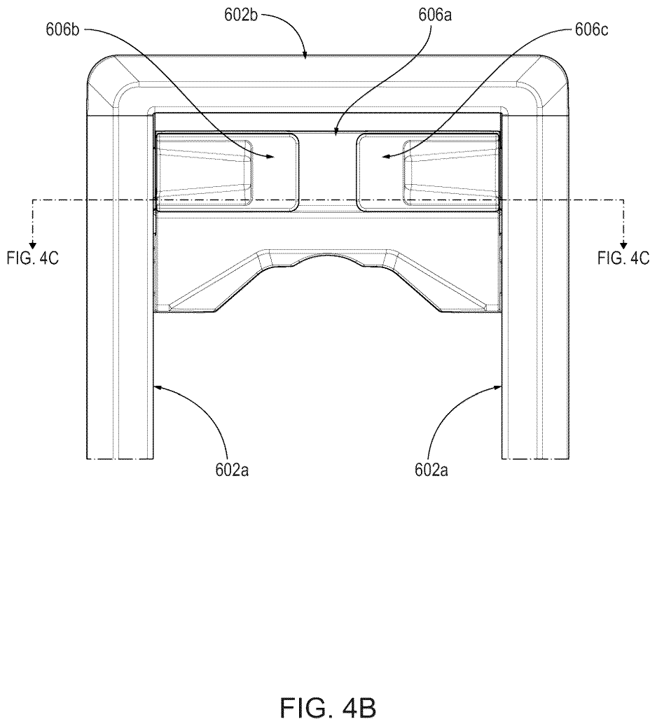

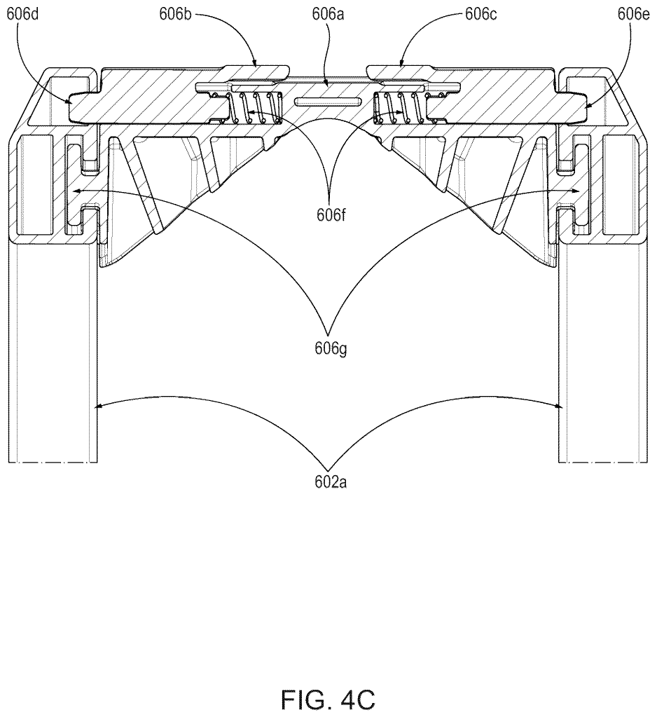

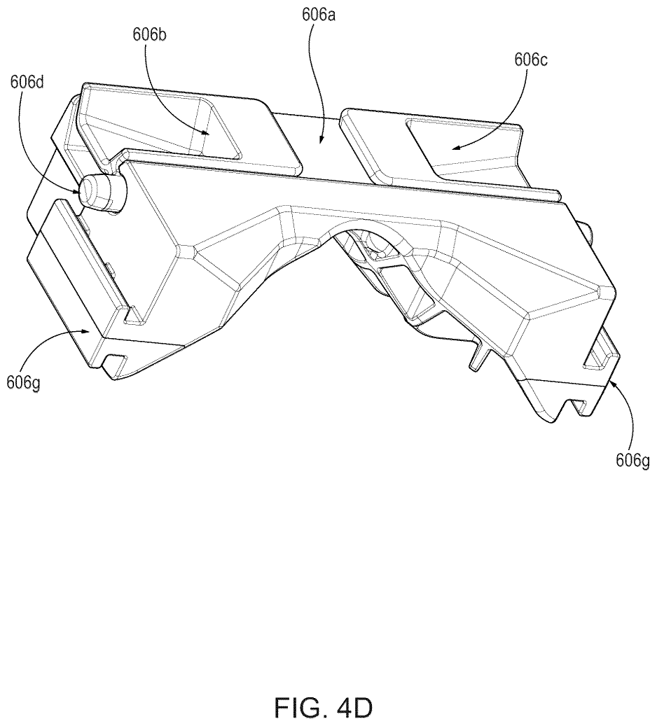

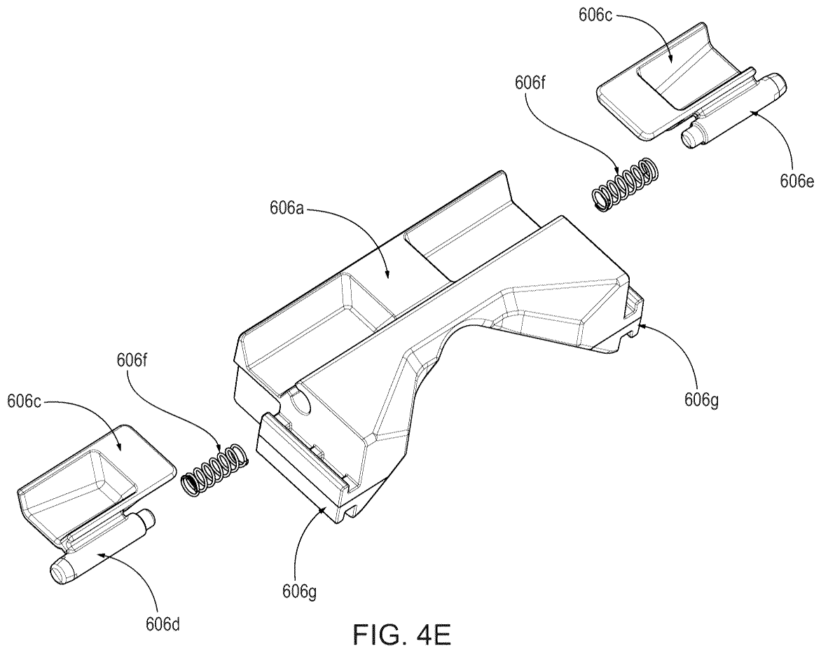

U.S. Pat. No. 11,639,210 claims an adjustable tire chock for use on a tire securement arm. FIGS. 4A through 4E disclose an improved version of such an adjustable tire chock 606. The improved tire chock slides in channels in the tire arm and has positioning holes that don't extend all the way through the tire arm. Both of these improvements keep the outer surface of the tire arm less cluttered with components or features, providing better strength and pleasing aesthetics.

In varying embodiments of the improved load carrier, the adjustable tire chock 606 comprises a chock body 606a with two retaining features 606g that are configured to slide in channels 602d in side members 602a of the tire securement arm. The channel 602d may have a t-shaped cross-section as in the depicted embodiment, or the cross-section may be cylindrical, rectangular, or of any other shape suitable to allow the features 606g to slide along the length of the channel 602d while holding the chock body 606a in place between the side arms 602a. The features 606g may be formed integrally with the chock body 606a or attached thereto by screws or another fastening device.

In the embodiment of the improved adjustable tire chock depicted in the figures, the tire chock 606 is provided with two actuators 606b and 606c that a user moves toward each other to extract the locking pins 606d and 606e from apertures 602e in the side arms 602a. The apertures 602e may be placed at specific locations on the tire arm side members that work best with standard bicycle tire sizes. In some of the inventive load carriers such as depicted in the figures, the pins 606d and 606e do not extend completely through the width of the side member 602a. An embodiment of this can be seen in FIG. 4C which depicts the pins 606d and 606e fully inserted into an aperture 602e. The ends of the pins 606d and 606e are disposed inside the side arms 602a.

The improvements to the adjustable chock 606 contribute to better functioning of the chock. The use of partial apertures 602e and channel 602d result in smoother adjustment of the chock, reduce entry of debris into the mechanism, provide a more streamlined look to the arm members 602e, and increase the strength of the arm 602a by reducing unnecessary holes in its structure.

### Tire Securement Arm Embodiments

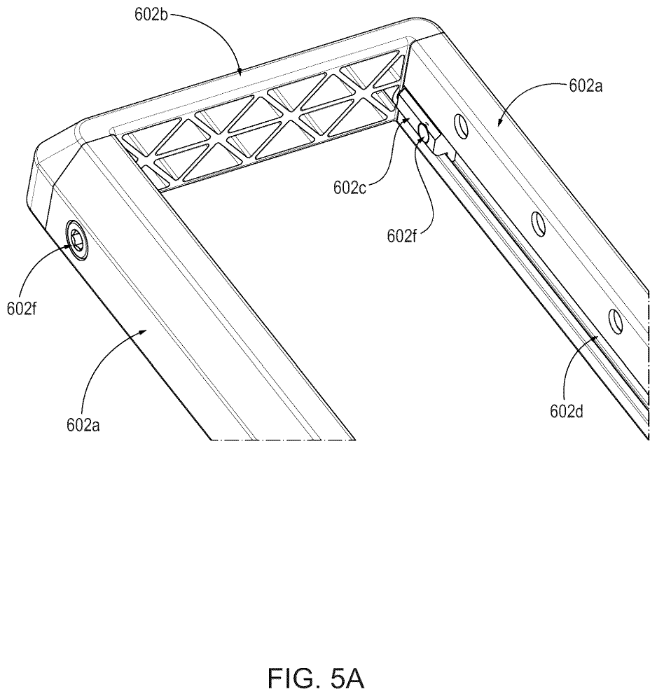

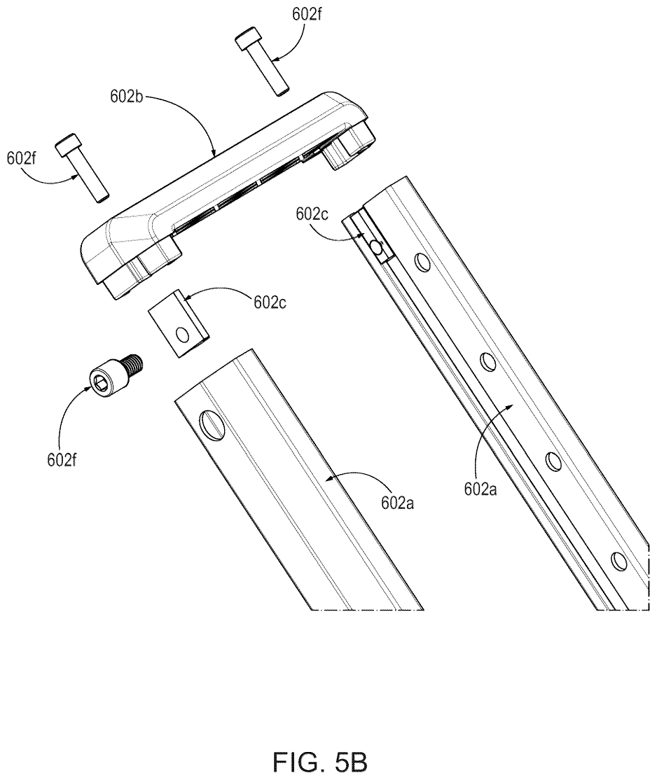

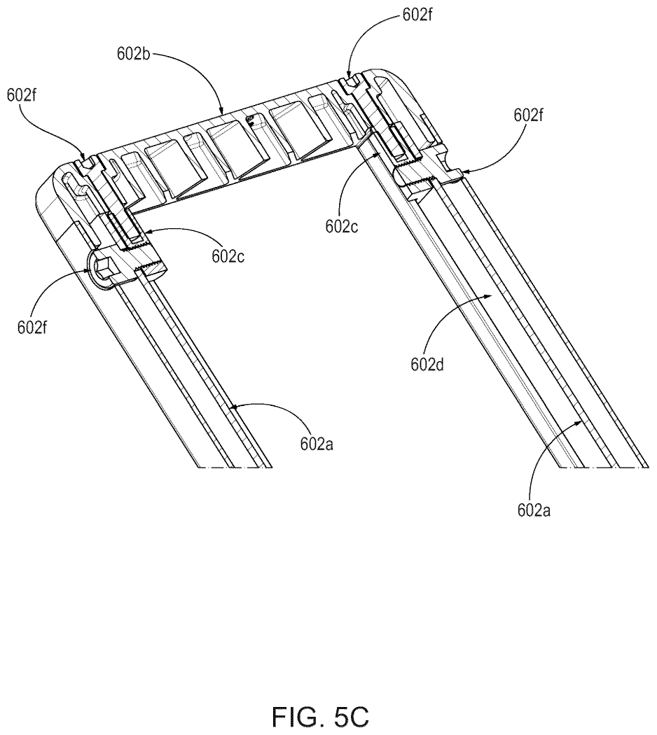

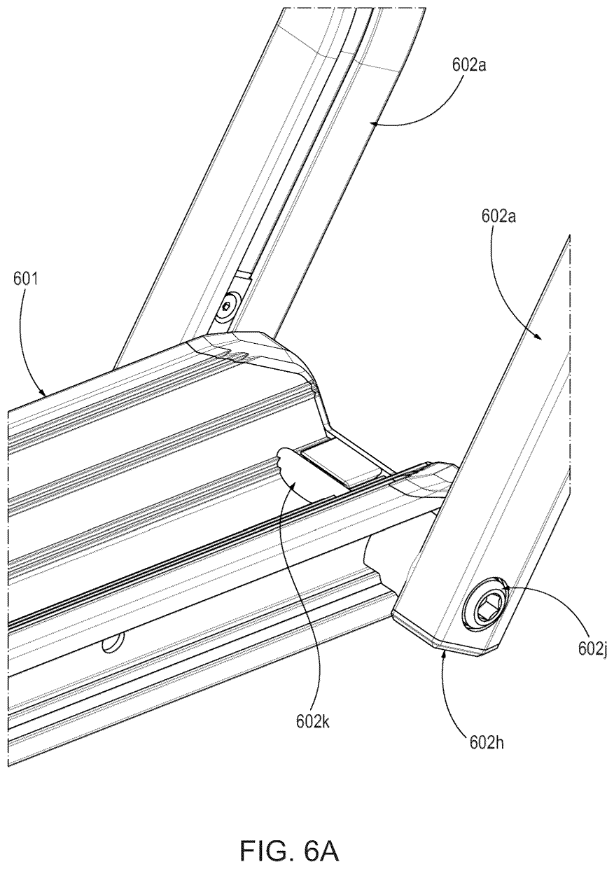

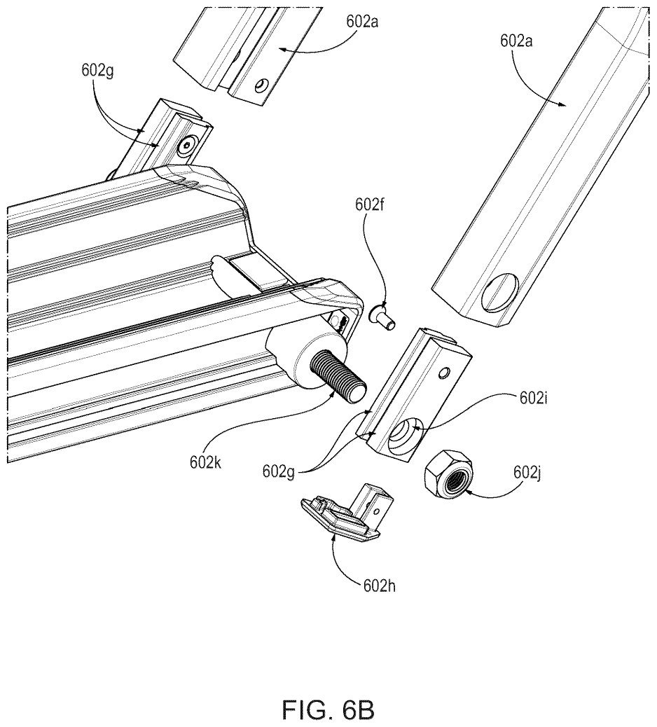

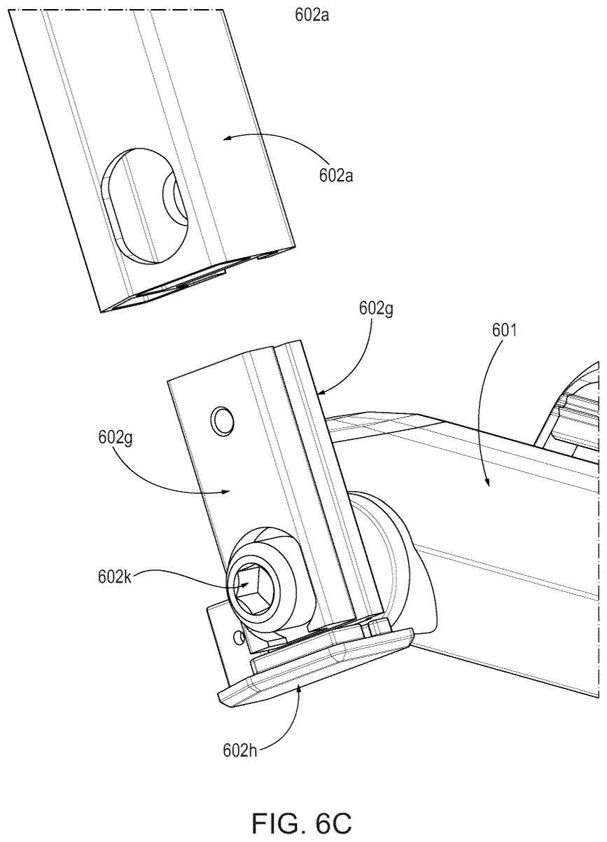

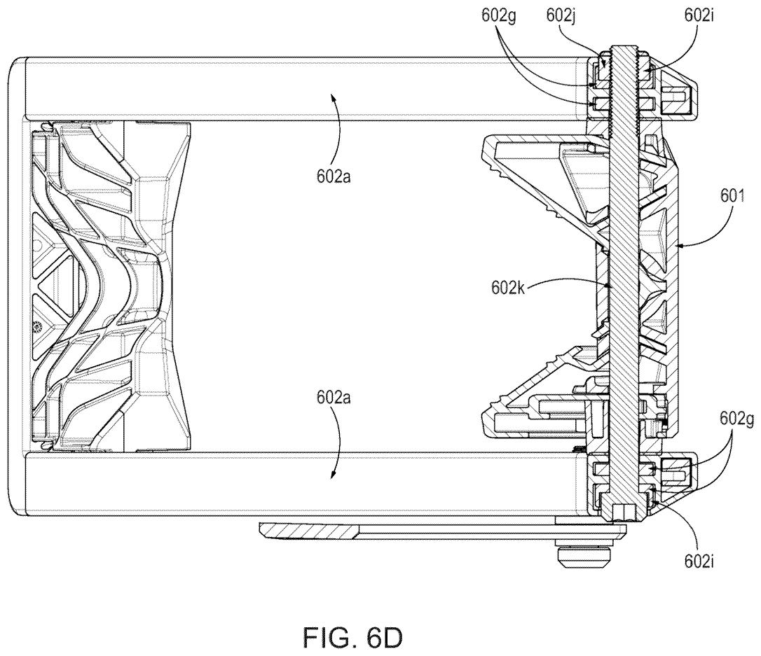

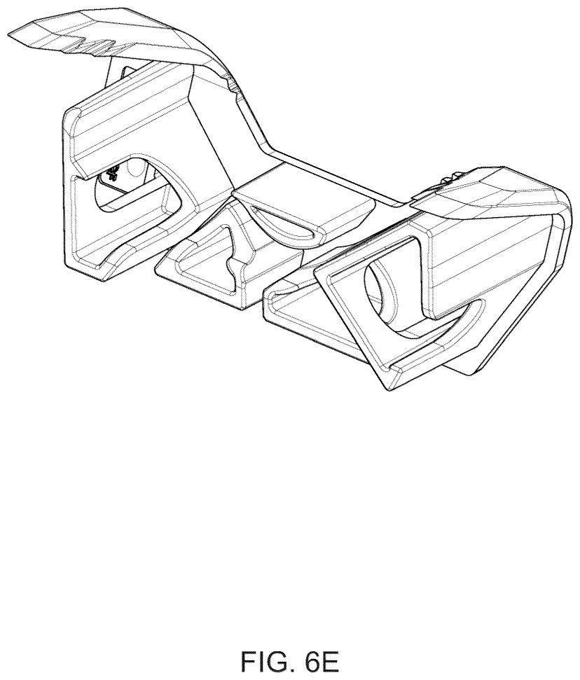

Some embodiments of the inventive load carrier utilize tire securement arms to hold the bicycle tires 900 in place on the base member 601. FIGS. 5A through 6E depict embodiments of inventive tire securement arms. In some embodiments of the inventive load carrier, it comprises tire securement arms with internal structural blocks to increase strength and bearing capacity at key points such as at the pivoting connection to the base tray and at the distal end. The extra strength where required allows the rest of the arm to be made from lighter components.

FIGS. 5A through 5C depict an embodiment of the distal end of an embodiment of the inventive tire securement arm 602. In this embodiment the distal end of the tire securement arm comprises an end member 602b that connects the two side members 602a. The two side members 602 comprise at least one internal channel 602d that is configured to receive a corner block 602c, which in some embodiments may have a t-shaped cross-section such as that depicted in the figures. Other cross-sections of this channel may be suitable as described in relation to the adjustable tire chock above. In the depicted embodiments, a corner block 602c is attached to the end of each side member 602a, for example by a fastener 602f which may be a threaded bolt inserted through an aperture in the side member 602a and received by a threaded aperture in the corner block 602c. The end member 602 is provided with two apertures for fasteners 602f to attach to both corner blocks 602c, such as machine screws 602f received by threaded apertures in corner block 602c. End member 602b may further comprise protrusions that are received by cavities inside members 602a to provide added stability to the joint.

Referring to FIGS. 6A through 6D, an improved attachment of the proximal end of the tire securement arm to the base member 601a is depicted. The proximal end of the arm 602 is pivotally attached to the base 601. This pivotal connection requires strength sufficient to support the tire arm 602 and the clamping forces applied to it during use to secure a bicycle tire in place. Thus, in typical tire arm designs the strength needed at the pivotal connection may determine the size and weight of an extrusion used for the entire length of the arm, even though that strength may not be required throughout the length of the arm. The improved tire arm 602 disclosed herein contains structural elements at the pivotal connection of the tire arm and base member that allow lighter or thinner materials to be used for the full length of the tire arm 602.

In vary embodiments the distal end of the tire arm 602 is pivotally attached to the base member 601 by a pivot bolt 602k which may be secured in place by a nut 602j. In varying embodiments of the improved tire arm one or more structural blocks 602g are disposed in cavities in the tire arm 602 to provide load bearing support to the bolt 602k and nut 602j. The structural blocks may be rectangular as those depicted in the figures, but they may also have any cross-sectional shape necessary to partially or completely fill a cavity within the side member 602a. The blocks 602g may extend varying distances along the arm depending on the strength requirements selected for the design such as bicycle weight and arm length. In the depicted embodiment the blocks are 50 mm long. In other embodiments the blocks may be between 50 and 200 mm long. In other embodiments the blocks are between 25 and 75 mm long. In other embodiments the blocks extend along a first linear section of the side member 602a. The depicted structural blocks include apertures for receiving the pivot bolt 602k so that the compression of the bolt and nut 602j bears on the structural blocks 602g.

In some embodiments, more than one internal structural unit may be fastened together by a bolt, machine screw, or other fastener to squeeze an internal baffle of the side member 602a. In some embodiments a structural block is provided with an aperture or cavity 602i for receiving the nut 602j or the head of bolt 602k to allow partial or complete recessing of those components into the side arm 602a. In some embodiments an end cap 602h for side member 602a has protrusions that extend into cavities in the side member 602a. The protrusions may match the cross-section of the structural blocks and abut or be adjacent when installed, or the structural blocks may be integrated with the end cap as protrusions thereof.

FIG. 6B depicts an exploded view of one side member 602a and its structural blocks 602g. FIG. 6C depicts the other side member 602a and its structural blocks with only the side member 602a translated upwardly to leave the structural blocks 602g and end cap 602h in their positions when installed in the side member 602a.

In some embodiments a structural end cap is provided for the base member 601 that extends into one or more cavities in base member 601. The structural end cap may extend around or past the pivot bolt 602k to provide additional support thereto. The protrusions on the end cap may partially or completely fill some or all of the cavities in the base member 601.

The improved tire securement arm structure for both the distal and proximal ends of the tire securement arm provides stronger tire securement arms with lighter extrusions. This reduces weight, cost, and material requirements.

### Support Arm Embodiments

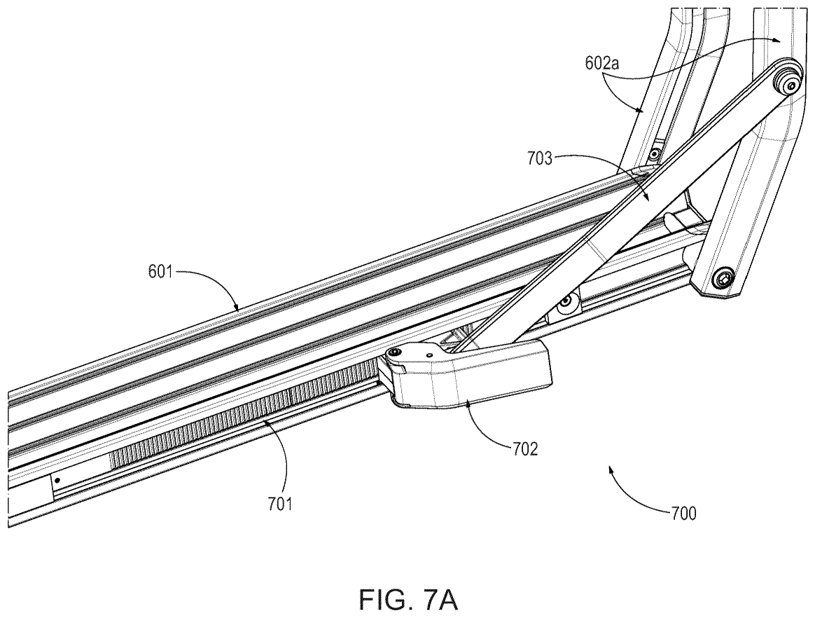

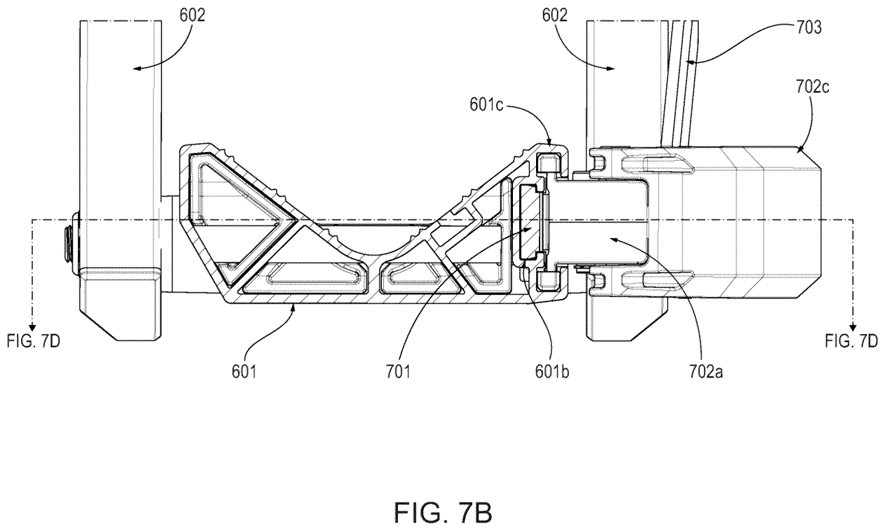

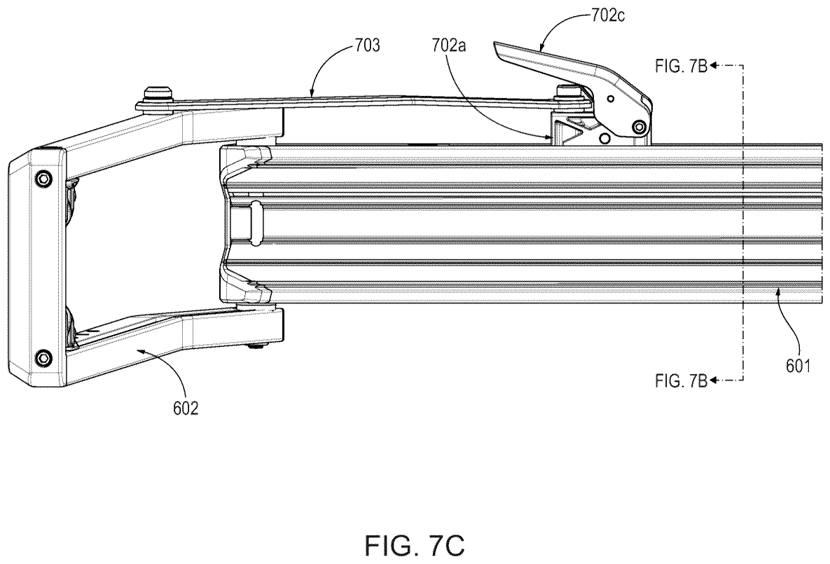

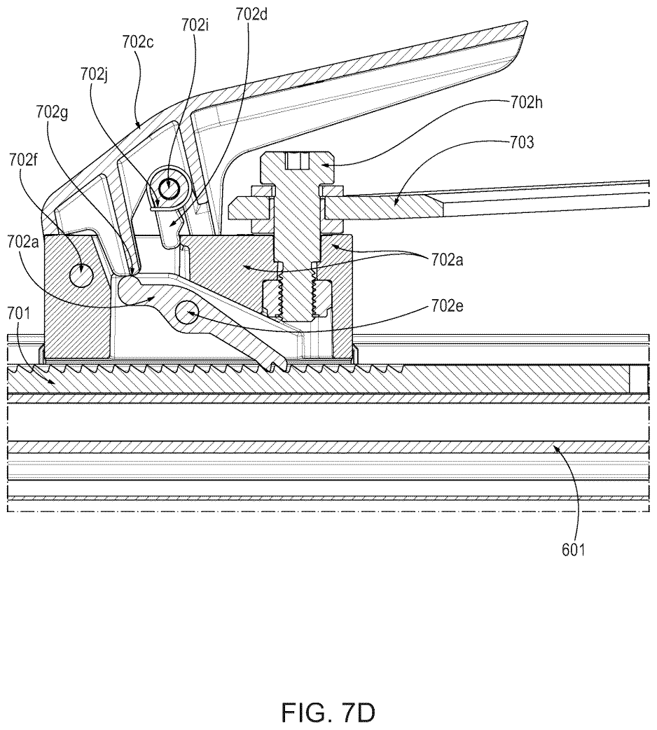

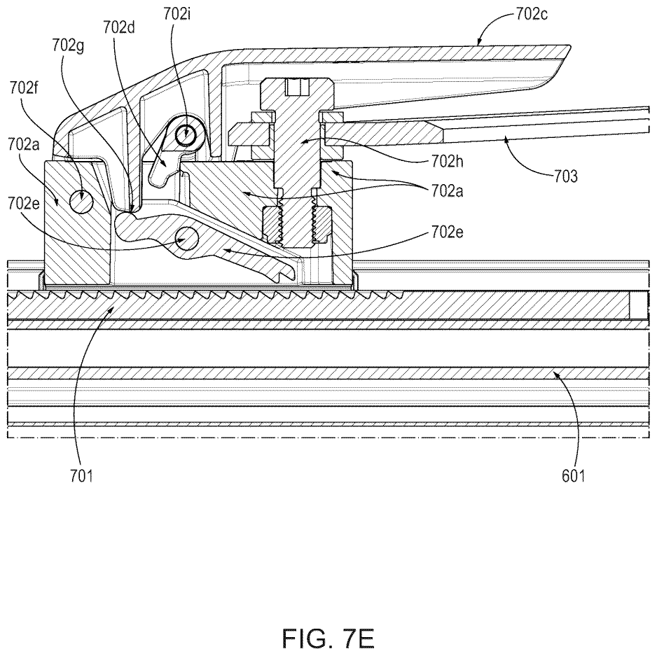

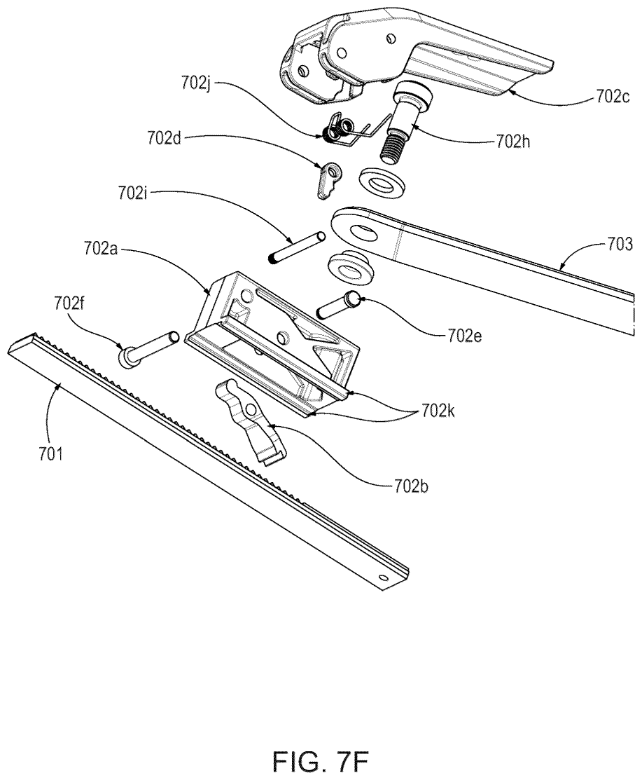

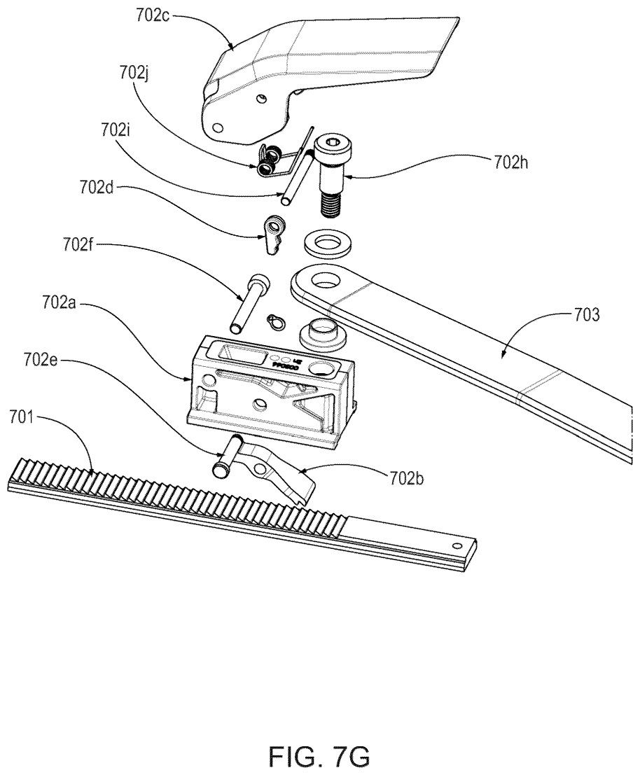

In some embodiments of the inventive load carrier the tire securement arm 602 is held in position by a support arm assembly with a releasable latch mechanism. An embodiment of an inventive support arm assembly and latch mechanism is depicted in FIGS. 7A through 7G.

Various embodiments of the inventive adjustable support arm 700 include a linear rail component 701, a latch assembly 702, and a support arm member 703. The support arm 703 is pivotally attached at one end to the latch assembly 702 and at the other end to the tire securement arm 602. The slidable adjustment of the latch assembly 702 along the rail component allows the tire securement arm 602 to be pivoted with respect to base member 601 to a desired position (such as closed, open, or clamped on a bicycle tire), and then fixed in place by engaging the latch assembly 702.

The latch assembly 702 and rail component 701 may have varying mechanisms but function to allow the latch assembly 702 to slide along the rail component 701 and then be fixed in place at a desired place by engaging the latch assembly 702 to fix it to the rail component 701. This may be a linear ratchet and pawl as depicted in the embodiment in the figures, or it could be other mechanisms of fixing the latch assembly in place at a desired point on the rail component 701.

In varying embodiments of the inventive load carrier the rail component 701 is disposed inside a cavity or channel 601b of the base member 601. In the depicted embodiment, the linear ratchet component 701 is disposed in cavity or channel with an opening wide enough to allow the ratchet pawl in the latch mechanism 702 to engage the teeth of the component 701. The depicted embodiment of channel 601b has edges that overlap part of the outer surface of component 701 to help hold it in place, but it may also or additionally be held in place by bolts, machine screws, or other fasteners connecting to base member 601.

In some embodiments the base member 601 is also provided with one or more channels 601c for slidably supporting latch assembly 702. In some embodiments, the channels 601c are integrated into the base member 601. In some embodiments the channels 601b and 601c are integrally formed as part of the extrusion of a metal to create the base member 601. In the depicted embodiment the latch assembly comprises a latch body 702a with two flanges 702k that are configured to slide in channels 601c. The latch body 702a pivotally supports a ratchet pawl 702b on pin 702e positioned to selectively engage and disengage teeth on the linear ratchet 701 to allow the tire arm 602 to close (pivot toward the base member 601) at any time but when engaged to prevent the tire arm 602 from opening (pivot away from the base member 601). The support arm 703 may be pivotally attached to the latch body 702a by fastener 702h such as a bolt or machine screw. In the depicted embodiment an actuator 702c is pivotally mounted on latch body 702a by pin 702i, and has a contact surface 702g to press on a portion of the pawl 702b to disengage it from the linear ratchet 701. The latch assembly 702 may be provided with a biasing mechanism such as lever 702d and spring 702j to urge the actuator away from the ratchet pawl 702d and allow engagement between the ratchet pawl 702b and the linear ratchet 701 unless a user is pressing on the actuator 702c. A additional biasing mechanism such as a spring may be provided for the ratchet pawl to urge it into engagement with linear ratchet 701 in the absence of a displacing force from the actuator 702c.

### Lower Front Tire Chock Embodiments

In some embodiments of the load carrier, a lower front tire chock is provided to give extra support to a front tire in conjunction with a tire chock on a rear tire. The tire chock may have a shape designed to provide resistance to turning or twisting of the front tire as well as rolling of the tire on the tray.

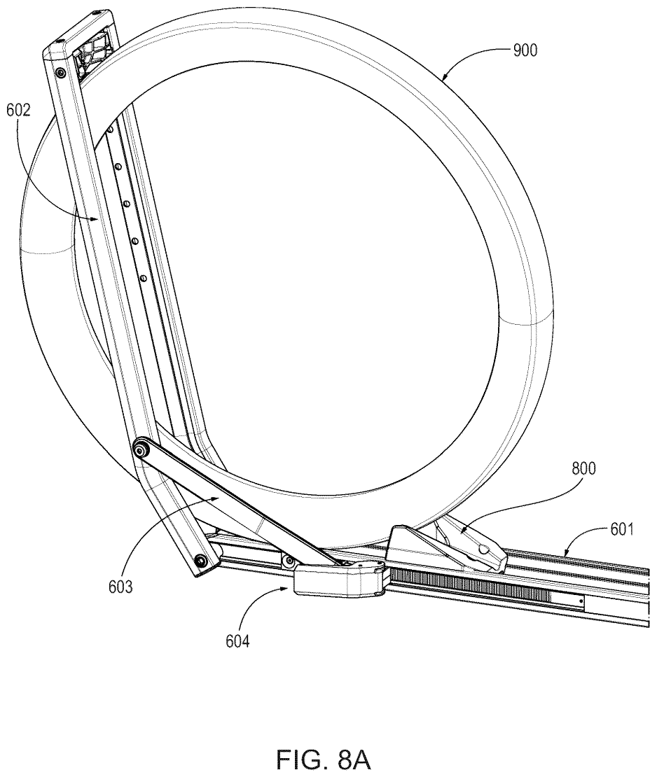

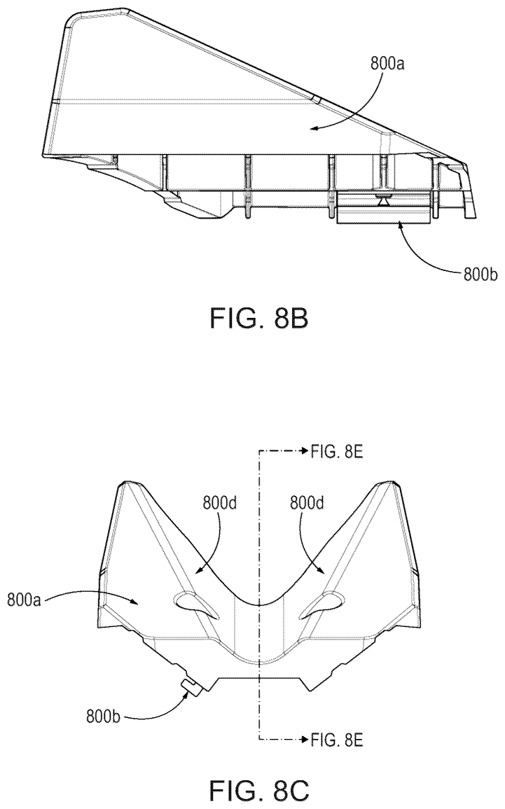

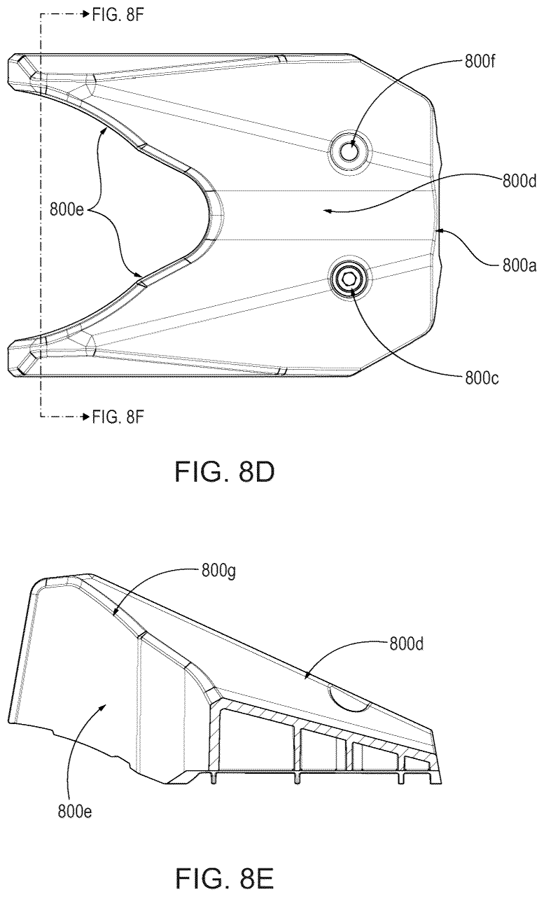

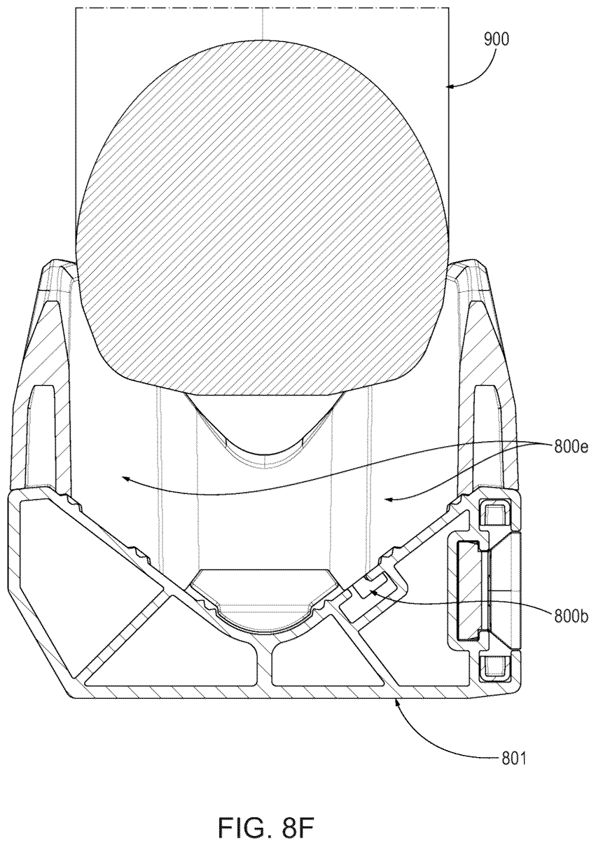

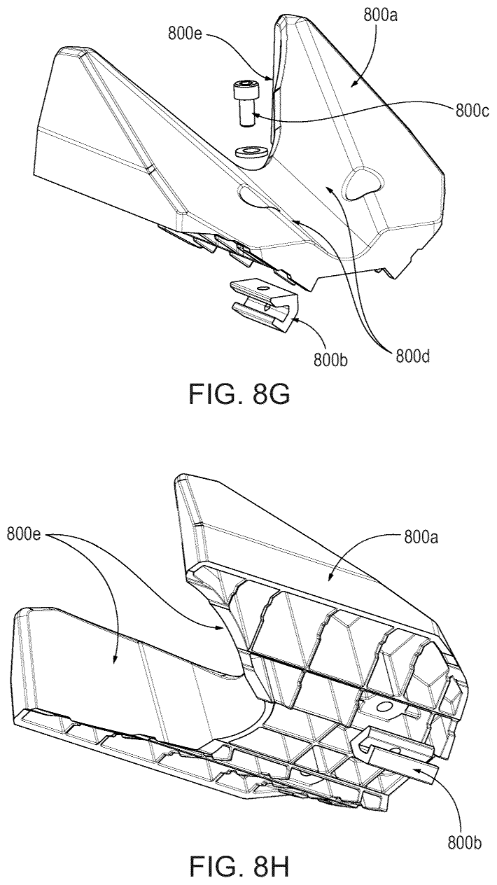

Referring now to FIGS. 8A through 8H, an optional embodiment of the inventive load carrier is shown with a lower front tire chock 800. In FIG. 8A, the lower front tire chock 800 is disposed on a bicycle support assembly 600. In this version the lower front tire chock 800 is adjustably attached to the base member 601 of the assembly 600. When a bicycle tire 900 is secured between the base member 601 and a tire securement arm 602 the chock 800 provides additional support to the tire 900 to prevent it from moving longitudinally along base member 601 or from swinging laterally across the narrower width of base member 601. This provides additional clamping power for the tire securement arm 602 to hold heavier bicycles on base member 601. In some embodiments the lower front tire chock is used to brace the front tire of the bicycle, though in other embodiments it may be used to brace the rear tire of the bicycle.

In some embodiments, the upper surface of the body 800a of the tire chock 800 may be designed to facilitate loading of a bicycle onto the carrier 100 by having an angled ramp face 800d that a bicycle tire 900 may easily roll up and over. The ramp face 800d may comprise two angled faces forming a valley or a v-shaped or u-shaped surface to guide the tire 900 up over the center of the chock 800. The depicted embodiment of the bottom of body 800a is shaped to all or partially rest on the surface of base member 601, although in other embodiments it may rest all or partially on brackets or some other intermediate support members.

In some embodiments the tire chock 800 is adjustably attached to the base member 601 to allow it to slide along the longitudinal axis of the base member 601 to adjust for varying sizes of bicycle tire 900. In the depicted embodiment the chock body 800a is attached to a retaining member 800b by a fastener 800c such as a machine screw. In the depicted embodiment the retaining member 800b has a plate with a threaded aperture for receiving the fastener 800c to securely hold the chock body 800a and the retaining member 800b together. The depicted embodiment of the retaining member 800b also comprises a flange configured to side in a channel in the base member 601. In various embodiments the tightening of fastener 800c pulls the retaining member 800b toward the chock body 800a. In some embodiments this squeezes a flange of the channel in the base 601 between the chock body 800a and the retaining member 800b sufficient to prevent the chock 800 from sliding along the base member 601. In those embodiments, a user may partially loosen the fastener 800c enough to allow the chock 800 to slide to a desired position before retightening it prior to us. In some embodiments, the fully tightened fastener 800c may create a sufficiently tight fit of the flange of the channel in the base 601 between the chock body 800a and the retaining member 800b such that the pressure of a tire 900 will not cause it to move possibly due in part to its non-parallel force direction on the chock, while a user may carefully apply a force parallel to the base member 601 to overcome the friction fit and move the chock 800 along the base 601 without loosening the fastener 800c.

In varying embodiments, the tire chock 800 has a retaining face 800e opposite the ramp face 800d. The retaining face 800e is configured to resist or hinder rolling or sliding movement of a tire 900 over the chock 800 when the tire 900 is retained between the base 601 and the arm 602. In the depicted embodiment, the retaining face 800e is substantially perpendicular to the longitudinal axis of the base member 601, however in other embodiments it may be overhanging (forming an acute angle with the longitudinal axis of the base member 601) or reclining (forming an obtuse angle with the longitudinal axis of the base member 601).

As depicted in the top-down view of FIG. 8D, some embodiments of the retaining face 800e may have a u-shaped or v-shaped aspect to better receive and retain a tire 900 through contact on both side walls of a tire 900. In some embodiments, such as the depicted embodiment the retaining face has curvatures on its aspect to better receive and retain a tire 900 through increased contact area between the chock body 800 and the tire 900. In some embodiments the face 800e has areas of different curvature to receive different width tires. For example, the depicted embodiment has a narrow area with a tighter radius of curvature to receive the narrow tires of road bicycles and a wider area of curvature to receive wider mountain bike tires. In some embodiments the radius of curvature of at least one part of the retaining face 800e is between 12 and 18 mm. In some embodiments the radius of curvature of at least one part of the retaining face 800e is substantially 15 mm. In some embodiments the radius of curvature of at least one part of the retaining face 800e is between 60 and 80 mm. In some embodiments the radius of curvature of at least one part of the retaining face is substantially 70 mm. In some embodiments the retaining face 800e has a first curved section substantially on the centerline of the chock body 800, and a second curved section and a third curved section disposed laterally on opposite sides of the first curved section. In some embodiments the radius of curvature of the first curved section is less than the radius of curvature of the second and third curved sections. In some embodiments the second and third curved sections have substantially the same radius of curvature. In some embodiments the first curved section has a radius of curvature between 12 and 18 mm. In some embodiments the first curved section has a radius of curvature of 15 mm. In some embodiments the second and third curved sections have a radius of curvature between 60 and 80 mm. In some embodiments the second and third curved sections have a radius of curvature of substantially 70 mm.

In some embodiments the tire 900 mainly contacts the chock 800 along an edge 800g between the ramp face 800d and the retaining face 800e. The edge 800g may be chamfered or have a radius to increase surface area contact with tire 900. In some embodiments the edge 800g extends at an acute angle upwardly with respect to the longitudinal axis of the base member 601. In some embodiments the angle is between 25° and 65°. In some embodiments the angle is between 40° and 45°. In some embodiments the angle is substantially 41°. In some embodiments different sections of the edge may have different angles. The configuration of the retaining face and the angle of the edge resists turning of the front wheel of the bicycle when it is on the carrier.

The following item lists A, B, C, etc. are illustrative, but not limiting, of embodiments of the inventive device. Features of the following item lists may constitute features of the other item lists. The reference numbers provided in the item descriptions are for ease of reference to the figures and shall not be construed as limiting their subject matter.

A1. A load carrier for a vehicle, the load carrier comprising a vehicle attachment portion, a pivot mechanism connected to the vehicle attachment portion, and a support beam connected to the pivot mechanism, wherein the pivot mechanism comprises a safety mechanism configured to prevent disengagement of the pivot mechanism.

A2. The load carrier according to A1, wherein the pivot mechanism further comprises an actuator configured to disengage the pivot mechanism.

A3. The load carrier according to any of the preceding A items, wherein the safety mechanism comprises a safety release actuator and a safety latch mounted on the pivot mechanism, wherein the safety release actuator is configured to disengage the safety latch from the pivot mechanism.

A4. The load carrier according to any of the preceding A items, wherein the safety latch comprises a pin configured to prevent the pivot mechanism from pivoting when the pin is in an engaged position.

A5. The load carrier according to any of the preceding A items, wherein the safety mechanism is mounted on the actuator of the pivot mechanism.

A6. The load carrier according to any of the preceding A items, wherein the safety latch is a locking pin disposed in a hole in the actuator of the pivot mechanism, wherein the locking pin is configured to extend into a hole in the pivot mechanism in an engaged position.

A7. The load carrier according to any of the preceding A items, wherein the safety release actuator is rotatably mounted on the actuator of the pivot mechanism.

A8. The load carrier according to any of the preceding A items, wherein rotation of the safety release actuator is configured to retract the locking pin from the aperture in the pivot mechanism.

A9. The load carrier according to any of the preceding A items, wherein the locking pin is configured to prevent actuation of the pivot mechanism actuator when the locking pin is in the engaged position.

A10. The load carrier according to any of the preceding A items, wherein the safety mechanism further comprises a safety indicator component with a visual warning indicator.

A11. The load carrier according to any of the preceding A items, wherein the visual warning indicator is visible only when the locking pin is in the disengaged position.

A12. The load carrier according to any of the preceding A items, wherein the visual warning indicator is visible when the locking pin is not in the engaged position.

A13. The load carrier according to any of the preceding A items, wherein the safety indicator component is disposed in a cavity in the safety release actuator.

A14. The load carrier according to any of the preceding A items, wherein the safety indicator component extends out of the cavity in the safety release actuator to reveal the visual warning indicator when the locking pin is disengaged from the aperture in the pivot mechanism.

A15. The load carrier according to any of the preceding A items, wherein the safety release actuator is rotatably attached to the pivot mechanism.

A16. The load carrier according to any of the preceding A items, wherein the safety release actuator is rotatably attached to the actuator of the pivot mechanism.

A17. The load carrier according to any of the preceding A items, wherein an interior surface the cavity of safety release actuator comprises a protrusion, and an exterior surface of the safety indicator component comprises an inclined plane, and rotation of the safety release actuator pushes the protrusion against the inclined plane to translate the safety indicator component out of the cavity in the safety release actuator.

A18. The load carrier according to any of the preceding A items, the safety mechanism further comprising a biasing mechanism to urge the locking pin into the engaged position.

A19. The load carrier according to any of the preceding A items, wherein when the locking pin is in the engaged position, the actuator for the pivot mechanism cannot be actuated to release the pivot mechanism.

A20. The load carrier according to any of the preceding A items, wherein the locking pin can only engage the aperture in the pivot mechanism when the pivot mechanism is in a locked configuration.

A21. The load carrier according to any of the preceding A items, wherein the locking pin only aligns with the aperture in the pivot mechanism when the pivot mechanism and the actuator for the pivot mechanism are both in latched positions.

A22. The load carrier according to any of the preceding A items, wherein the pivot mechanism engages to hold the support beam in a stowed configuration and a deployed configuration.

A23. The load carrier according to any of the preceding A items wherein the pivot mechanism engages to hold the support beam in multiple positions with respect to the support beam.

A24. The load carrier according to any of the preceding A items wherein the pivot mechanism engages to hold the support beam in a declined configuration.

B1. A load carrier for a vehicle, the load carrier comprising a base member, a tire securement arm, a support arm, and a latch assembly, wherein the tire securement arm is pivotally attached to the base member, and the support arm is adjustably attached to the tire securement arm and the base member.

B2. The load carrier according to B1, wherein a first end of the support arm is pivotally attached to the tire securement arm.

B3. The load carrier according to any of the preceding B items, wherein a second end of the support arm is slidably attached to the base member.

B4. The load carrier according to any of the preceding B items, wherein the latch assembly connects the second end of the support arm to the base member.

B5. The load carrier according to any of the preceding B items, wherein the latch assembly further comprises a latch body member slidably retained in a channel in the base member.

B6. The load carrier according to any of the preceding B items, wherein the latch body member comprises at least one flange configured to slide in a channel in the base member.

B7. The load carrier according to any of the preceding B items, wherein the second end of the support arm is pivotally attached to the latch body member.

B8. The load carrier according to any of the preceding B items, wherein the latch assembly further comprises a latch pin for engaging the base member.

B9. The load carrier according to any of the preceding B items, wherein the latch assembly further comprises a trigger configured to disengage the latch pin from the base member.

B10. The load carrier according to any of the preceding B items, further comprising a latch plate attached to the base member.

B11. The load carrier according to any of the preceding B items, wherein the latch pin engages the latch plate.

B12. The load carrier according to any of the preceding B items, wherein the latch pin comprises a ratchet pawl and the latch plate comprises a linear ratchet.

B13. The load carrier according to any of the preceding B items, wherein the trigger comprises a lever connected to the latch body member and configured to disengage the ratchet pawl from the linear ratchet.

B14. The load carrier according to any of the preceding B items, wherein the latch pin, when engaged with the latch plate, prevents the latch body member from translating toward a distal end of the base member.

B15. The load carrier according to any of the preceding B items, wherein the lever is configured to disengage the latch pin from the latch plate to allow the latch body member to translate toward a distal end of the base member.

B16. The load carrier according to any of the preceding B items, further comprising a biasing mechanism configured to urge the latch pin into engagement with the latch plate.

B17. The load carrier according to any of the preceding B items, wherein the latch plate is positioned in a groove in the base member.

B18. The load carrier according to any of the preceding B items, wherein the groove in the base member for receiving the latch plate is disposed in the channel for the latch body member.

C1. A load carrier for a vehicle, the load carrier comprising a base member, a tire securement arm, and an internal reinforcing member disposed in a cavity in the base, wherein a first end of the tire securement arm is pivotally attached to the base member.

C2. The load carrier according to C1, wherein the base member and the tire securement arm are extruded components.

C3. The load carrier according to any of the preceding C items, wherein the internal reinforcing member comprises a portion of an end cap for the base member.

C4. The load carrier according to any of the preceding C items, wherein a pivot bolt for the tire securement arm is disposed through an aperture in the reinforcing member.

C5. The load carrier according to any of the preceding C items, further comprising a structural block disposed in a cavity in a first end of the tire securement arm.

C6. The load carrier according to any of the preceding C items, wherein the pivot bolt for the tire securement arm is disposed through an aperture in the structural block.

C7. The load carrier according to any of the preceding C items, wherein the reinforcing member comprises at least one rigid or semi-rigid protrusion that contacts the walls of a cavity in the base member.

C8. The load carrier according to any of the preceding C items, wherein the structural block comprises a rigid or semi-rigid body that contact the walls of a cavity in the tire securement arm.

C9. The load carrier according to any of the preceding C items, wherein the reinforcing member provides support to the walls of a cavity in the base member.

C10. The load carrier according to any of the preceding C items, wherein the reinforcing member provides support to the walls of a cavity in the tire securement arm.

C11. The load carrier according to any of the preceding C items, wherein the structural block is partially disposed in the interior of the tire securement arm.

C12. The load carrier according to any of the preceding C items, wherein the reinforcing member is partially disposed in the interior of the base member.

C13. The load carrier according to any of the preceding C items, wherein the structural block comprises an end cap for the tire securement arm.

C14. The load carrier according to any of the preceding C items, wherein the structural block comprises a hollow component.

C15. The load carrier according to any of the preceding C items, wherein the retaining member is a hollow component.

C16. The load carrier according to any of the preceding C items, wherein the retaining member is partially hollow.

C17. The load carrier according to any of the preceding C items, wherein the structural block is partially hollow.

D1. A load carrier for a vehicle, the load carrier comprising a base member, a tire securement arm, and a movable tire chock disposed on the base member.

D2. The load carrier according to D1, wherein the movable tire chock slides along a longitudinal axis of the base member.

D3. The load carrier according to any of the preceding D items, wherein the tire chock comprises a chock body and a retaining component.

D4. The load carrier according to any of the preceding D items, wherein the retaining component comprises a flange slidably disposed in a channel in the base member.

D5. The load carrier according to any of the preceding D items, wherein the movable tire chock comprises a chock body and a tire retention strap.

D5. The load carrier according to any of the preceding D items, wherein the tire retention strap is disposed in a channel in the chock body.

D6. The load carrier according to any of the preceding D items, wherein the tire retention strap is disposed between the chock body and the base member.

D7. The load carrier according to any of the preceding D items, wherein the tire retention strap is disposed through an aperture in the chock body.

D8. The load carrier according to any of the preceding D items, wherein the tire retention strap comprises a ratchet strap.

D9. The load carrier according to any of the preceding D items, wherein the tire retention strap comprises a hook and look fastener.

D10. The load carrier according to any of the preceding D items, wherein the tire chock body comprises a first ramp surface.

D11. The load carrier according to any of the preceding D items, wherein the tire chock body has a second ramp surface.

D12. The load carrier according to any of the preceding D items, wherein the first ramp surface is at a steeper angle with respect to the base member than the second ramp surface.

D13. The load carrier according to any of the preceding D items, wherein the tire retention strap is disposed adjacent to the first ramp surface.

D14. The load carrier according to any of the preceding D items, wherein the tire retention strap is disposed adjacent to the second ramp surface.

D15. The load carrier according to any of the preceding D items, wherein the tire retention strap is configured to secure a bicycle tire to the chock body.

D16. The load carrier according to any of the preceding D items, wherein the tire retention strap is configured to secure a bicycle tier to the first ramp surface.

D17. The load carrier according to any of the preceding D items, wherein the retaining component is integrally formed with the chock body.

D18. The load carrier according to any of the preceding D items, wherein the first ramp surface comprises a V-shaped cross-section.

D19. The load carrier according to any of the preceding D items, wherein the first ramp surface comprises a U-shaped cross-section.

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. The terms “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value). “Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

Aspects of the present disclosure are described in detail with reference to aspects thereof as illustrated in the accompanying drawings. References to “one aspect,” “an aspect,” “some aspects,” “an embodiment,” “varying embodiments,” etc., indicate that the aspect(s) described may include a particular feature, structure, or characteristic, but every aspect or embodiment may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

1. A load carrier for a vehicle, the load carrier comprising:
a vehicle attachment portion,
a pivot mechanism connected to the vehicle attachment portion, and
a support beam connected to the pivot mechanism, and
a safety mechanism configured to prevent disengagement of the pivot mechanism,
wherein the pivot mechanism engages to hold the support beam in a stowed position and a deployed position with respect to the support beam.

2. The load carrier of claim 1, wherein the safety mechanism comprises a safety release actuator and a safety latch mounted on the pivot mechanism,
wherein the safety release actuator is configured to disengage the safety latch from the pivot mechanism.

3. The load carrier of claim 2, wherein the safety latch comprises a locking pin configured to prevent the pivot mechanism from pivoting when the locking pin is in an engaged position.

4. The load carrier of claim 2, further comprising an actuator configured to disengage the pivot mechanism,
wherein the safety mechanism is mounted on the actuator.

5. The load carrier of claim 4, wherein the safety latch is a pin disposed in an aperture in the actuator of the pivot mechanism, wherein the pin is configured to extend into an aperture in the pivot mechanism when in an engaged position.

6. The load carrier of claim 5, wherein the safety release actuator is rotatably mounted on the actuator of the pivot mechanism.

7. The load carrier of claim 6, wherein rotation of the safety release actuator is configured to retract the pin from the aperture in the pivot mechanism.

8. The load carrier of claim 5, wherein the pin is configured to prevent movement of the actuator of the pivot mechanism when the pin is in the engaged position.

9. The load carrier of claim 2, wherein the safety mechanism further comprises a safety indicator component with a visual warning indicator.

10. The load carrier of claim 9, wherein the visual warning indicator is visible only when the safety latch is in a disengaged position.

11. The load carrier of claim 9, wherein the visual warning indicator is visible when the safety latch is not in an engaged position.

12. The load carrier of claim 9, wherein the safety indicator component is disposed in a cavity in the safety release actuator.

13. The load carrier of claim 12, wherein the safety indicator component is configured to extend out of the cavity in the safety release actuator to reveal the visual warning indicator when the locking pin is in a disengaged position.

14. The load carrier of claim 12, wherein an interior surface of the cavity of safety release actuator comprises a protrusion, and an exterior surface of the safety indicator component comprises an inclined plane, and rotation of the safety release actuator pushes the protrusion against the inclined plane to translate the safety indicator component out of the cavity in the safety release actuator.

15. The load carrier of claim 5, the safety mechanism further comprising a biasing mechanism to urge the pin into the engaged position.

16. The load carrier of claim 5, wherein when the pin is in the engaged position, the actuator for the pivot mechanism cannot be moved to release the pivot mechanism.

17. The load carrier of claim 5, wherein the pin is configured to engage the aperture in the pivot mechanism only when the pivot mechanism is in a locked configuration.

18. The load carrier of claim 5, wherein the pin aligns with the aperture in the pivot mechanism only when the pivot mechanism and the actuator for the pivot mechanism are both in a latched position.

19. The load carrier of claim 9, wherein the visual warning indicator comprises a red area on an exterior surface of the safety indicator component.

20. The load carrier of claim 19, wherein the red area is not visible when the pin is in an engaged position.
